(19) United States
(12) Patent Application Publication
(10) Pub. No.: US 2024/0353553 A1
(43) Pub. Date: Oct. 24, 2024

(54) RADAR APPARATUS, SYSTEM, AND METHOD

(71) Applicant: MobilEye Vision Technologies Ltd., Jerusalem (IL)

(72) Inventors: Daniel Gudinetsky, Givatayim (IL); Moshe Teplitsky, Tel-Aviv (IL); Adi Panzer, Tel-Aviv (IL); Ilia Yoffe, Hod-HaSharon (IL); Alon Cohen, Modi’in-Maccabim-Reut (IL)

(73) Assignee: MobilEye Vision Technologies Ltd., Jerusalem (IL)

(21) Appl. No.: 18/608,700

(22) Filed: Mar. 18, 2024

Related U.S. Application Data
(60) Provisional application No. 63/494,236, filed on Apr. 5, 2023.

(51) Int. Cl. G01S 13/58; G01S 7/03; G01S 7/35; G01S 13/34; G01S 13/931

(52) U.S. Cl. CPC G01S 13/584; G01S 7/032; G01S 7/356; G01S 13/343; G01S 13/931

(57) ABSTRACT

For example, a processor may be configured to process Range-Doppler (RD) information corresponding to an RD bin to identify a first plurality of values corresponding to a first plurality of virtual antennas of a virtual antenna array and a second plurality of values corresponding to a second plurality of virtual antennas of the virtual antenna array. For example, the RD information corresponding to the RD bin may be based on radar Receive (Rx) signals received by a plurality of Rx antennas based on radar Transmit (Tx) signals from a Tx array including a first plurality of Tx antennas and a second plurality of Tx antennas. For example, the processor may be configured to determine one or more estimated RD-Azimuth (RDAz) based (RDAz-based) Doppler folds corresponding to one or more RDAz bins, for example, based on the first plurality of values and the second plurality of values.

### CROSS REFERENCE

This application claims the benefit of, and priority from, U.S. Provisional Patent Application No. 63/494,236 entitled “RADAR APPARATUS, SYSTEM, AND METHOD”, filed Apr. 5, 2023, the entire disclosure of which is incorporated herein by reference.

### BACKGROUND

Various types of devices and systems, for example, autonomous and/or robotic devices, e.g., autonomous vehicles and robots, may be configured to perceive and navigate through their environment using sensor data of one or more sensor types.

Conventionally, autonomous perception relies heavily on light-based sensors, such as image sensors, e.g., cameras, and/or Light Detection and Ranging (LiDAR) sensors. Such light-based sensors may perform poorly under certain conditions, such as, conditions of poor visibility, or in certain inclement weather conditions, e.g., rain, snow, hail, or other forms of precipitation, thereby limiting their usefulness or reliability.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a vehicle implementing a radar, in accordance with some demonstrative aspects.

FIG. 2 is a schematic block diagram illustration of a robot implementing a radar, in accordance with some demonstrative aspects.

FIG. 3 is a schematic block diagram illustration of a radar apparatus, in accordance with some demonstrative aspects.

FIG. 4 is a schematic block diagram illustration of a Frequency-Modulated Continuous Wave (FMCW) radar apparatus, in accordance with some demonstrative aspects.

FIG. 5 is a schematic illustration of an extraction scheme, which may be implemented to extract range and speed (Doppler) estimations from digital reception radar data values, in accordance with some demonstrative aspects.

FIG. 6 is a schematic illustration of an angle-determination scheme, which may be implemented to determine Angle of Arrival (AoA) information based on an incoming radio signal received by a receive antenna array, in accordance with some demonstrative aspects.

FIG. 7 is a schematic illustration of a Multiple-Input-Multiple-Output (MIMO) radar antenna scheme, which may be implemented based on a combination of Transmit (Tx) and Receive (Rx) antennas, in accordance with some demonstrative aspects.

FIG. 8 is a schematic block diagram illustration of elements of a radar device including a radar frontend and a radar processor, in accordance with some demonstrative aspects.

FIG. 9 is a schematic illustration of a radar system including a plurality of radar devices implemented in a vehicle, in accordance with some demonstrative aspects.

FIG. 10 is a schematic illustration of signals of a 2×4 MIMO antenna array, which may be implemented in accordance with some demonstrative aspects.

FIG. 11 is a schematic illustration of an antenna array and an overlapped virtual antenna array based on the antenna array, which may be implemented in accordance with some demonstrative aspects.

FIG. 12 is a schematic illustration of a system, in accordance with some demonstrative aspects.

FIGS. 13A, 13B, and 13C are conceptual illustrations of operations according to a radar processing technique to generate Doppler fold information, in accordance with some demonstrative aspects.

FIG. 14 is a schematic flow-chart illustration of a method of processing Range-Doppler (RD) information, in accordance with some demonstrative aspects.

FIG. 15 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

The words “exemplary” and “demonstrative” are used herein to mean “serving as an example, instance, demonstration, or illustration”. Any aspect, or design described herein as “exemplary” or “demonstrative” is not necessarily to be construed as preferred or advantageous over other aspects, or designs.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

The phrases “at least one” and “one or more” may be understood to include a numerical quantity greater than or equal to one, e.g., one, two, three, four, [ . . . ], etc. The phrase “at least one of” with regard to a group of elements may be used herein to mean at least one element from the group consisting of the elements. For example, the phrase “at least one of” with regard to a group of elements may be used herein to mean one of the listed elements, a plurality of one of the listed elements, a plurality of individual listed elements, or a plurality of a multiple of individual listed elements.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and/or may represent any information as understood in the art.

The terms “processor” or “controller” may be understood to include any kind of technological entity that allows handling of any suitable type of data and/or information. The data and/or information may be handled according to one or more specific functions executed by the processor or controller. Further, a processor or a controller may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), and the like, or any combination thereof. Any other kind of implementation of the respective functions, which will be described below in further detail, may also be understood as a processor, controller, or logic circuit. It is understood that any two (or more) processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

The term “memory” is understood as a computer-readable medium (e.g., a non-transitory computer-readable medium) in which data or information can be stored for retrieval. References to “memory” may thus be understood as referring to volatile or non-volatile memory, including random access memory (RAM), read-only memory (ROM), flash memory, solid-state storage, magnetic tape, hard disk drive, optical drive, among others, or any combination thereof. Registers, shift registers, processor registers, data buffers, among others, are also embraced herein by the term memory. The term “software” may be used to refer to any type of executable instruction and/or logic, including firmware.

A “vehicle” may be understood to include any type of driven object. By way of example, a vehicle may be a driven object with a combustion engine, an electric engine, a reaction engine, an electrically driven object, a hybrid driven object, or a combination thereof. A vehicle may be, or may include, an automobile, a bus, a mini bus, a van, a truck, a mobile home, a vehicle trailer, a motorcycle, a bicycle, a tricycle, a train locomotive, a train wagon, a moving robot, a personal transporter, a boat, a ship, a submersible, a submarine, a drone, an aircraft, a rocket, among others.

A “ground vehicle” may be understood to include any type of vehicle, which is configured to traverse the ground, e.g., on a street, on a road, on a track, on one or more rails, off-road, or the like.

An “autonomous vehicle” may describe a vehicle capable of implementing at least one navigational change without driver input. A navigational change may describe or include a change in one or more of steering, braking, acceleration/deceleration, or any other operation relating to movement, of the vehicle. A vehicle may be described as autonomous even in case the vehicle is not fully autonomous, for example, fully operational with driver or without driver input. Autonomous vehicles may include those vehicles that can operate under driver control during certain time periods, and without driver control during other time periods. Additionally or alternatively, autonomous vehicles may include vehicles that control only some aspects of vehicle navigation, such as steering, e.g., to maintain a vehicle course between vehicle lane constraints, or some steering operations under certain circumstances, e.g., not under all circumstances, but may leave other aspects of vehicle navigation to the driver, e.g., braking or braking under certain circumstances. Additionally or alternatively, autonomous vehicles may include vehicles that share the control of one or more aspects of vehicle navigation under certain circumstances, e.g., hands-on, such as responsive to a driver input; and/or vehicles that control one or more aspects of vehicle navigation under certain circumstances, e.g., hands-off, such as independent of driver input. Additionally or alternatively, autonomous vehicles may include vehicles that control one or more aspects of vehicle navigation under certain circumstances, such as under certain environmental conditions, e.g., spatial areas, roadway conditions, or the like. In some aspects, autonomous vehicles may handle some or all aspects of braking, speed control, velocity control, steering, and/or any other additional operations, of the vehicle. An autonomous vehicle may include those vehicles that can operate without a driver. The level of autonomy of a vehicle may be described or determined by the Society of Automotive Engineers (SAE) level of the vehicle, e.g., as defined by the SAE, for example in SAE J3016 2018: Taxonomy and definitions for terms related to driving automation systems for on road motor vehicles, or by other relevant professional organizations. The SAE level may have a value ranging from a minimum level, e.g., level 0 (illustratively, substantially no driving automation), to a maximum level, e.g., level 5 (illustratively, full driving automation).

An “assisted vehicle” may describe a vehicle capable of informing a driver or occupant of the vehicle of sensed data or information derived therefrom.

The phrase “vehicle operation data” may be understood to describe any type of feature related to the operation of a vehicle. By way of example, “vehicle operation data” may describe the status of the vehicle, such as, the type of tires of the vehicle, the type of vehicle, and/or the age of the manufacturing of the vehicle. More generally, “vehicle operation data” may describe or include static features or static vehicle operation data (illustratively, features or data not changing over time). As another example, additionally or alternatively, “vehicle operation data” may describe or include features changing during the operation of the vehicle, for example, environmental conditions, such as weather conditions or road conditions during the operation of the vehicle, fuel levels, fluid levels, operational parameters of the driving source of the vehicle, or the like. More generally, “vehicle operation data” may describe or include varying features or varying vehicle operation data (illustratively, time varying features or data).

Some aspects may be used in conjunction with various devices and systems, for example, a radar sensor, a radar device, a radar system, a vehicle, a vehicular system, an autonomous vehicular system, a vehicular communication system, a vehicular device, an airborne platform, a waterborne platform, road infrastructure, sports-capture infrastructure, city monitoring infrastructure, static infrastructure platforms, indoor platforms, moving platforms, robot platforms, industrial platforms, a sensor device, a User Equipment (UE), a Mobile Device (MD), a wireless station (STA), a sensor device, a non-vehicular device, a mobile or portable device, and the like.

Some aspects may be used in conjunction with Radio Frequency (RF) systems, radar systems, vehicular radar systems, autonomous systems, robotic systems, detection systems, or the like.

Some demonstrative aspects may be used in conjunction with an RF frequency in a frequency band having a starting frequency above 10 Gigahertz (GHz), for example, a frequency band having a starting frequency between 10 GHz and 120 GHz. For example, some demonstrative aspects may be used in conjunction with an RF frequency having a starting frequency above 30 GHz, for example, above 45 GHZ, e.g., above 60 GHz. For example, some demonstrative aspects may be used in conjunction with an automotive radar frequency band, e.g., a frequency band between 76 GHz and 81 GHz. However, other aspects may be implemented utilizing any other suitable frequency bands, for example, a frequency band above 140 GHz, a frequency band of 300 GHz, a sub Terahertz (THz) band, a THz band, an Infra-Red (IR) band, and/or any other frequency band.

As used herein, the term “circuitry” may refer to, be part of, or include, an Application Specific Integrated Circuit (ASIC), an integrated circuit, an electronic circuit, a processor (shared, dedicated, or group), and/or memory (shared, dedicated, or group), that execute one or more software or firmware programs, a combinational logic circuit, and/or other suitable hardware components that provide the described functionality. In some aspects, some functions associated with the circuitry may be implemented by, one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g., radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and/or the like. Logic may be executed by one or more processors using memory, e.g., registers, buffers, stacks, and the like, coupled to the one or more processors, e.g., as necessary to execute the logic.

The term “communicating” as used herein with respect to a signal includes transmitting the signal and/or receiving the signal. For example, an apparatus, which is capable of communicating a signal, may include a transmitter to transmit the signal, and/or a receiver to receive the signal. The verb communicating may be used to refer to the action of transmitting or the action of receiving. In one example, the phrase “communicating a signal” may refer to the action of transmitting the signal by a transmitter, and may not necessarily include the action of receiving the signal by a receiver. In another example, the phrase “communicating a signal” may refer to the action of receiving the signal by a receiver, and may not necessarily include the action of transmitting the signal by a transmitter.

The term “antenna”, as used herein, may include any suitable configuration, structure and/or arrangement of one or more antenna elements, components, units, assemblies and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a MIMO (Multiple-Input Multiple-Output) array antenna, a single element antenna, a set of switched beam antennas, and/or the like. In one example, an antenna may be implemented as a separate element or an integrated element, for example, as an on-module antenna, an on-chip antenna, or according to any other antenna architecture.

Some demonstrative aspects are described herein with respect to RF radar signals. However, other aspects may be implemented with respect to, or in conjunction with, any other radar signals, wireless signals, IR signals, acoustic signals, optical signals, wireless communication signals, communication scheme, network, standard, and/or protocol. For example, some demonstrative aspects may be implemented with respect to systems, e.g., Light Detection Ranging (LiDAR) systems, and/or sonar systems, utilizing light and/or acoustic signals.

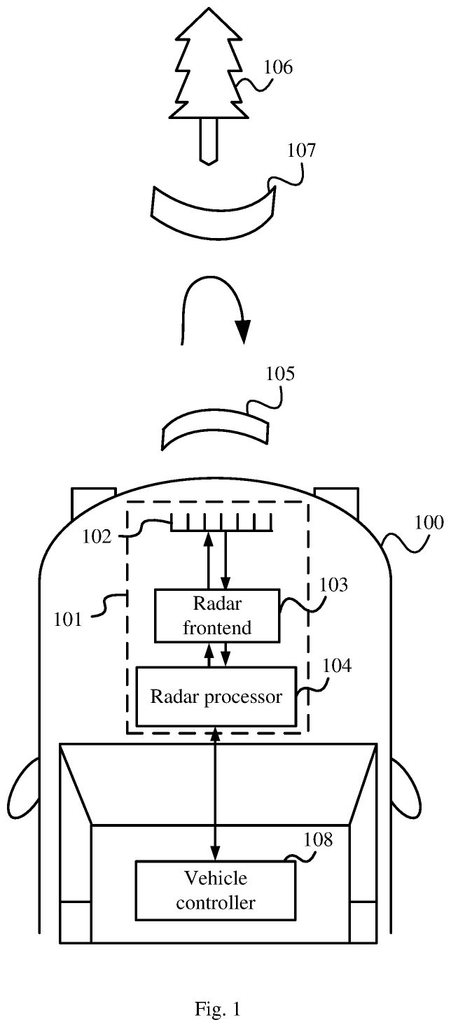

Reference is now made to FIG. 1, which schematically illustrates a block diagram of a vehicle 100 implementing a radar, in accordance with some demonstrative aspects.

In some demonstrative aspects, vehicle 100 may include a car, a truck, a motorcycle, a bus, a train, an airborne vehicle, a waterborne vehicle, a cart, a golf cart, an electric cart, a road agent, or any other vehicle.

In some demonstrative aspects, vehicle 100 may include a radar device 101, e.g., as described below. For example, radar device 101 may include a radar detecting device, a radar sensing device, a radar sensor, or the like, e.g., as described below.

In some demonstrative aspects, radar device 101 may be implemented as part of a vehicular system, for example, a system to be implemented and/or mounted in vehicle 100.

In one example, radar device 101 may be implemented as part of an autonomous vehicle system, an automated driving system, an assisted vehicle system, a driver assistance and/or support system, and/or the like.

For example, radar device 101 may be installed in vehicle 100 for detection of nearby objects, e.g., for autonomous driving.

In some demonstrative aspects, radar device 101 may be configured to detect targets in a vicinity of vehicle 100, e.g., in a far vicinity and/or a near vicinity, for example, using RF and analog chains, capacitor structures, large spiral transformers and/or any other electronic or electrical elements, e.g., as described below.

In one example, radar device 101 may be mounted onto, placed, e.g., directly, onto, or attached to, vehicle 100.

In some demonstrative aspects, vehicle 100 may include a plurality of radar aspects, vehicle 100 may include a single radar device 101.

In some demonstrative aspects, vehicle 100 may include a plurality of radar devices 101, which may be configured to cover a field of view of 360 degrees around vehicle 100.

In other aspects, vehicle 100 may include any other suitable count, arrangement, and/or configuration of radar devices and/or units, which may be suitable to cover any other field of view, e.g., a field of view of less than 360 degrees.

In some demonstrative aspects, radar device 101 may be implemented as a component in a suite of sensors used for driver assistance and/or autonomous vehicles, for example, due to the ability of radar to operate in nearly all-weather conditions.

In some demonstrative aspects, radar device 101 may be configured to support autonomous vehicle usage, e.g., as described below.

In one example, radar device 101 may determine a class, a location, an orientation, a velocity, an intention, a perceptional understanding of the environment, and/or any other information corresponding to an object in the environment.

In another example, radar device 101 may be configured to determine one or more parameters and/or information for one or more operations and/or tasks, e.g., path planning, and/or any other tasks.

In some demonstrative aspects, radar device 101 may be configured to map a scene by measuring targets' echoes (reflectivity) and discriminating them, for example, mainly in range, velocity, azimuth and/or elevation, e.g., as described below.

In some demonstrative aspects, radar device 101 may be configured to detect, and/or sense, one or more objects, which are located in a vicinity, e.g., a far vicinity and/or a near vicinity, of the vehicle 100, and to provide one or more parameters, attributes, and/or information with respect to the objects.

In some demonstrative aspects, the objects may include road users, such as other vehicles, pedestrians; road objects and markings, such as traffic signs, traffic lights, lane markings, road markings, road elements, e.g., a pavement-road meeting, a road edge, a road profile, road roughness (or smoothness); general objects, such as a hazard, e.g., a tire, a box, a crack in the road surface; and/or the like.

In some demonstrative aspects, the one or more parameters, attributes and/or information with respect to the object may include a range of the objects from the vehicle 100, an angle of the object with respect to the vehicle 100, a location of the object with respect to the vehicle 100, a relative speed of the object with respect to vehicle 100, and/or the like.

In some demonstrative aspects, radar device 101 may include a Multiple Input Multiple Output (MIMO) radar device 101, e.g., as described below. In one example, the MIMO radar device may be configured to utilize “spatial filtering” processing, for example, beamforming and/or any other mechanism, for one or both of Transmit (Tx) signals and/or Receive (Rx) signals.

Some demonstrative aspects are described below with respect to a radar device, e.g., radar device 101, implemented as a MIMO radar. However, in other aspects, radar device 101 may be implemented as any other type of radar utilizing a plurality of antenna elements, e.g., a Single Input Multiple Output (SIMO) radar or a Multiple Input Single output (MISO) radar.

Some demonstrative aspects may be implemented with respect to a radar device, e.g., radar device 101, implemented as a MIMO radar, e.g., as described below. However, in other aspects, radar device 101 may be implemented as any other type of radar, for example, an Electronic Beam Steering radar, a Synthetic Aperture Radar (SAR), adaptive and/or cognitive radars that change their transmission according to the environment and/or ego state, a reflect array radar, or the like.

In some demonstrative aspects, radar device 101 may include an antenna arrangement 102, a radar frontend 103 configured to communicate radar signals via the antenna arrangement 102, and a radar processor 104 configured to generate radar information based on the radar signals, e.g., as described below.

In some demonstrative aspects, radar processor 104 may be configured to process radar information of radar device 101 and/or to control one or more operations of radar device 101, e.g., as described below.

In some demonstrative aspects, radar processor 104 may include, or may be implemented, partially or entirely, by circuitry and/or logic, e.g., one or more processors including circuitry and/or logic, memory circuitry and/or logic. Additionally or alternatively, one or more functionalities of radar processor 104 may be implemented by logic, which may be executed by a machine and/or one or more processors, e.g., as described below.

In one example, radar processor 104 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In other aspects, radar processor 104 may be implemented by one or more additional or alternative elements of vehicle 100.

In some demonstrative aspects, radar frontend 103 may include, for example, one or more (radar) transmitters, and one or more (radar) receivers, e.g., as described below.

In some demonstrative aspects, antenna arrangement 102 may include a plurality of antennas to communicate the radar signals. For example, antenna arrangement 102 may include multiple transmit antennas in the form of a transmit antenna array, and multiple receive antennas in the form of a receive antenna array. In another example, antenna arrangement 102 may include one or more antennas used both as transmit and receive antennas. In the latter case, the radar frontend 103, for example, may include a duplexer or a circulator, e.g., a circuit to separate transmitted signals from received signals.

In some demonstrative aspects, as shown in FIG. 1, the radar frontend 103 and the antenna arrangement 102 may be controlled, e.g., by radar processor 104, to transmit a radio transmit signal 105.

In some demonstrative aspects, as shown in FIG. 1, the radio transmit signal 105 may be reflected by an object 106, resulting in an echo 107.

In some demonstrative aspects, the radar device 101 may receive the echo 107, e.g., via antenna arrangement 102 and radar frontend 103, and radar processor 104 may generate radar information, for example, by calculating information about position, radial velocity (Doppler), and/or direction of the object 106, e.g., with respect to vehicle 100.

In some demonstrative aspects, radar processor 104 may be configured to provide the radar information to a vehicle controller 108 of the vehicle 100, e.g., for autonomous driving of the vehicle 100.

In some demonstrative aspects, at least part of the functionality of radar processor 104 may be implemented as part of vehicle controller 108. In other aspects, the functionality of radar processor 104 may be implemented as part of any other element of radar device 101 and/or vehicle 100. In other aspects, radar processor 104 may be implemented, as a separate part of, or as part of any other element of radar device 101 and/or vehicle 100.

In some demonstrative aspects, vehicle controller 108 may be configured to control one or more functionalities, modes of operation, components, devices, systems and/or elements of vehicle 100.

In some demonstrative aspects, vehicle controller 108 may be configured to control one or more vehicular systems of vehicle 100, e.g., as described below.

In some demonstrative aspects, the vehicular systems may include, for example, a steering system, a braking system, a driving system, and/or any other system of the vehicle 100.

In some demonstrative aspects, vehicle controller 108 may configured to control radar device 101, and/or to process one or parameters, attributes and/or information from radar device 101.

In some demonstrative aspects, vehicle controller 108 may be configured, for example, to control the vehicular systems of the vehicle 100, for example, based on radar information from radar device 101 and/or one or more other sensors of the vehicle 100, e.g., Light Detection and Ranging (LIDAR) sensors, camera sensors, and/or the like.

In one example, vehicle controller 108 may control the steering system, the braking system, and/or any other vehicular systems of vehicle 100, for example, based on the information from radar device 101, e.g., based on one or more objects detected by radar device 101.

In other aspects, vehicle controller 108 may be configured to control any other additional or alternative functionalities of vehicle 100.

Some demonstrative aspects are described herein with respect to a radar device 101 implemented in a vehicle, e.g., vehicle 100. In other aspects a radar device, e.g., radar device 101, may be implemented as part of any other element of a traffic system or network, for example, as part of a road infrastructure, and/or any other element of a traffic network or system. Other aspects may be implemented with respect to any other system, environment and/or apparatus, which may be implemented in any other object, environment, location, or place. For example, radar device 101 may be part of a non-vehicular device, which may be implemented, for example, in an indoor location, a stationary infrastructure outdoors, or any other location.

In some demonstrative aspects, radar device 101 may be configured to support security usage. In one example, radar device 101 may be configured to determine a nature of an operation, e.g., a human entry, an animal entry, an environmental movement, and the like, to identity a threat level of a detected event, and/or any other additional or alternative operations.

Some demonstrative aspects may be implemented with respect to any other additional or alternative devices and/or systems, for example, for a robot, e.g., as described below.

In other aspects, radar device 101 may be configured to support any other usages and/or applications.

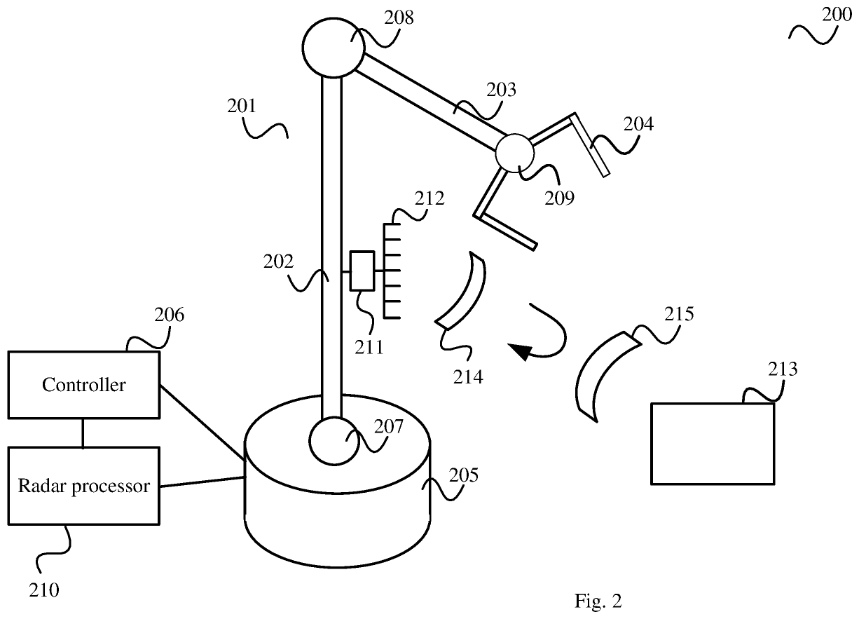

Reference is now made to FIG. 2, which schematically illustrates a block diagram of a robot 200 implementing a radar, in accordance with some demonstrative aspects.

In some demonstrative aspects, robot 200 may include a robot arm 201. The robot 200 may be implemented, for example, in a factory for handling an object 213, which may be, for example, a part that should be affixed to a product that is being manufactured. The robot arm 201 may include a plurality of movable members, for example, movable members 202, 203, 204, and a support 205. Moving the movable members 202, 203, and/or 204 of the robot arm 201, e.g., by actuation of associated motors, may allow physical interaction with the environment to carry out a task, e.g., handling the object 213.

In some demonstrative aspects, the robot arm 201 may include a plurality of joint elements, e.g., joint elements 207, 208, 209, which may connect, for example, the members 202, 203, and/or 204 with each other, and with the support 205. For example, a joint element 207, 208, 209 may have one or more joints, each of which may provide rotatable motion, e.g., rotational motion, and/or translatory motion, e.g., displacement, to associated members and/or motion of members relative to each other. The movement of the members 202, 203, 204 may be initiated by suitable actuators.

In some demonstrative aspects, the member furthest from the support 205, e.g., member 204, may also be referred to as the end-effector 204 and may include one or more tools, such as, a claw for gripping an object, a welding tool, or the like. Other members, e.g., members 202, 203, closer to the support 205, may be utilized to change the position of the end-effector 204, e.g., in three-dimensional space. For example, the robot arm 201 may be configured to function similarly to a human arm, e.g., possibly with a tool at its end.

In some demonstrative aspects, robot 200 may include a (robot) controller 206 configured to implement interaction with the environment, e.g., by controlling the robot arm's actuators, according to a control program, for example, in order to control the robot arm 201 according to the task to be performed.

In some demonstrative aspects, an actuator may include a component adapted to affect a mechanism or process in response to being driven. The actuator can respond to commands given by the controller 206 (the so-called activation) by performing mechanical movement. This means that an actuator, typically a motor (or electromechanical converter), may be configured to convert electrical energy into mechanical energy when it is activated (i.e. actuated).

In some demonstrative aspects, controller 206 may be in communication with a radar processor 210 of the robot 200.

In some demonstrative aspects, a radar fronted 211 and a radar antenna arrangement 212 may be coupled to the radar processor 210. In one example, radar fronted 211 and/or radar antenna arrangement 212 may be included, for example, as part of the robot arm 201.

In some demonstrative aspects, the radar frontend 211, the radar antenna arrangement 212 and the radar processor 210 may be operable as, and/or may be configured to form, a radar device. For example, antenna arrangement 212 may be configured to perform one or more functionalities of antenna arrangement 102 (FIG. 1), radar frontend 211 may be configured to perform one or more functionalities of radar frontend 103 (FIG. 1), and/or radar processor 210 may be configured to perform one or more functionalities of radar processor 104 (FIG. 1), e.g., as described above.

In some demonstrative aspects, for example, the radar frontend 211 and the antenna arrangement 212 may be controlled, e.g., by radar processor 210, to transmit a radio transmit signal 214.

In some demonstrative aspects, as shown in FIG. 2, the radio transmit signal 214 may be reflected by the object 213, resulting in an echo 215.

In some demonstrative aspects, the echo 215 may be received, e.g., via antenna arrangement 212 and radar frontend 211, and radar processor 210 may generate radar information, for example, by calculating information about position, speed (Doppler) and/or direction of the object 213, e.g., with respect to robot arm 201.

In some demonstrative aspects, radar processor 210 may be configured to provide the radar information to the robot controller 206 of the robot arm 201, e.g., to control robot arm 201. For example, robot controller 206 may be configured to control robot arm 201 based on the radar information, e.g., to grab the object 213 and/or to perform any other operation.

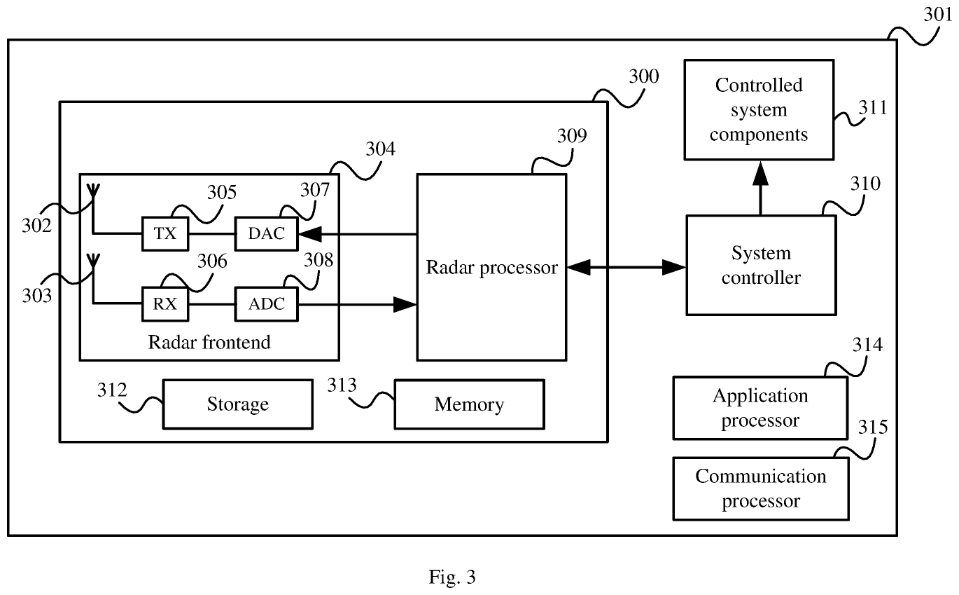

Reference is made to FIG. 3, which schematically illustrates a radar apparatus 300, in accordance with some demonstrative aspects.

In some demonstrative aspects, radar apparatus 300 may be implemented as part of a device or system 301, e.g., as described below.

For example, radar apparatus 300 may be implemented as part of, and/or may configured to perform one or more operations and/or functionalities of, the devices or systems described above with reference to FIG. 1 and/or FIG. 2. In other aspects, radar apparatus 300 may be implemented as part of any other device or system 301.

In some demonstrative aspects, radar device 300 may include an antenna arrangement, which may include one or more transmit antennas 302 and one or more receive antennas 303. In other aspects, any other antenna arrangement may be implemented.

In some demonstrative aspects, radar device 300 may include a radar frontend 304, and a radar processor 309.

In some demonstrative aspects, as shown in FIG. 3, the one or more transmit antennas 302 may be coupled with a transmitter (or transmitter arrangement) 305 of the radar frontend 304; and/or the one or more receive antennas 303 may be coupled with a receiver (or receiver arrangement) 306 of the radar frontend 304, e.g., as described below.

In some demonstrative aspects, transmitter 305 may include one or more elements, for example, an oscillator, a power amplifier and/or one or more other elements, configured to generate radio transmit signals to be transmitted by the one or more transmit antennas 302, e.g., as described below.

In some demonstrative aspects, for example, radar processor 309 may provide digital radar transmit data values to the radar frontend 304. For example, radar frontend 304 may include a Digital-to-Analog Converter (DAC) 307 to convert the digital radar transmit data values to an analog transmit signal. The transmitter 305 may convert the analog transmit signal to a radio transmit signal which is to be transmitted by transmit antennas 302.

In some demonstrative aspects, receiver 306 may include one or more elements, for example, one or more mixers, one or more filters and/or one or more other elements, configured to process, down-convert, radio signals received via the one or more receive antennas 303, e.g., as described below.

In some demonstrative aspects, for example, receiver 306 may convert a radio receive signal received via the one or more receive antennas 303 into an analog receive signal. The radar frontend 304 may include an Analog-to-Digital Converter (ADC) 308 to generate digital radar reception data values based on the analog receive signal. For example, radar frontend 304 may provide the digital radar reception data values to the radar processor 309.

In some demonstrative aspects, radar processor 309 may be configured to process the digital radar reception data values, for example, to detect one or more objects, e.g., in an environment of the device/system 301. This detection may include, for example, the determination of information including one or more of range, speed (Doppler), direction, and/or any other information, of one or more objects, e.g., with respect to the system 301.

In some demonstrative aspects, radar processor 309 may be configured to provide the determined radar information to a system controller 310 of device/system 301. For example, system controller 310 may include a vehicle controller, e.g., if device/system 301 includes a vehicular device/system, a robot controller, e.g., if device/system 301 includes a robot device/system, or any other type of controller for any other type of device/system 301.

In some demonstrative aspects, the radar information from radar processor 309 may be processed, e.g., by system controller 310 and/or any other element of system 301, for example, in combination with information from one or more other of information sources, for example, LiDAR information from a LiDAR processor, vision information from a vision-based processor, or the like.

In some demonstrative aspects, an environmental model of an environment of system 301 may be determined, e.g., by system controller 310 and/or any other element of system 301, for example, based on the radar information from radar processor 309, and/or the information from one or more other of information sources.

In some demonstrative aspects, a driving policy system, e.g., which may be implemented by system controller 310 and/or any other element of system 301, may process the environmental model, for example, to decide on one or more actions, which may be taken.

In some demonstrative aspects, system controller 310 may be configured to control one or more controlled system components 311 of the system 301, e.g., a motor, a brake, steering, and the like, e.g., by one or more corresponding actuators, for example, based on the one or more action decisions.

In some demonstrative aspects, radar device 300 may include a storage 312 or a memory 313, e.g., to store information processed by radar 300, for example, digital radar reception data values being processed by the radar processor 309, radar information generated by radar processor 309, and/or any other data to be processed by radar processor 309.

In some demonstrative aspects, device/system 301 may include, for example, an application processor 314 and/or a communication processor 315, for example, to at least partially implement one or more functionalities of system controller 310 and/or to perform communication between system controller 310, radar device 300, the controlled system components 311, and/or one or more additional elements of device/system 301.

In some demonstrative aspects, radar device 300 may be configured to generate and transmit the radio transmit signal in a form, which may support determination of range, speed, and/or direction, e.g., as described below.

For example, a radio transmit signal of a radar may be configured to include a plurality of pulses. For example, a pulse transmission may include the transmission of short high-power bursts in combination with times during which the radar device listens for echoes.

For example, in order to more optimally support a highly dynamic situation, e.g., in an automotive scenario, a continuous wave (CW) may instead be used as the radio transmit signal. However, a continuous wave, e.g., with constant frequency, may support velocity determination, but may not allow range determination, e.g., due to the lack of a time mark that could allow distance calculation.

In some demonstrative aspects, radio transmit signal 105 (FIG. 1) may be transmitted according to technologies such as, for example, Frequency-Modulated Continuous Wave (FMCW) radar, Phase-Modulated Continuous Wave (PMCW) radar, Orthogonal Frequency Division Multiplexing (OFDM) radar, and/or any other type of radar technology, which may support determination of range, velocity, and/or direction, e.g., as described below.

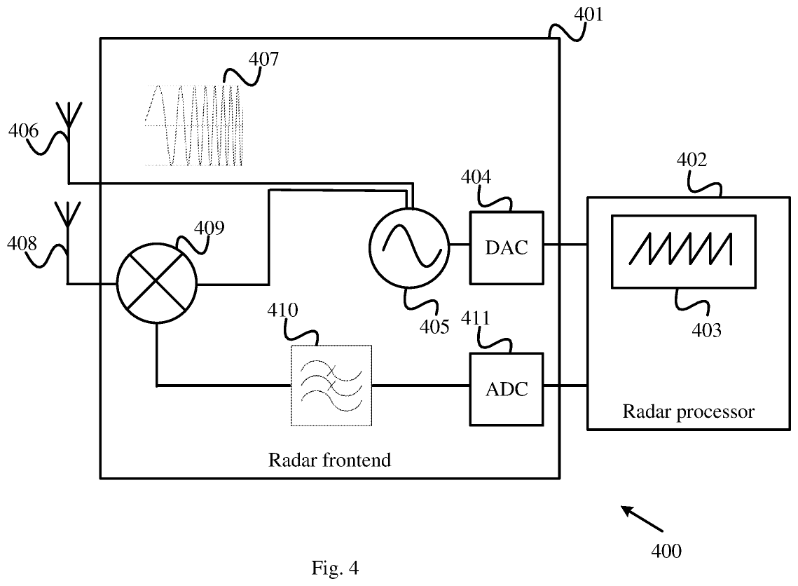

Reference is made to FIG. 4, which schematically illustrates a FMCW radar apparatus, in accordance with some demonstrative aspects.

In some demonstrative aspects, FMCW radar device 400 may include a radar frontend 401, and a radar processor 402. For example, radar frontend 304 (FIG. 3) may include one or more elements of, and/or may perform one or more operations and/or functionalities of, radar frontend 401; and/or radar processor 309 (FIG. 3) may include one or more elements of, and/or may perform one or more operations and/or functionalities of, radar processor 402.

In some demonstrative aspects, FMCW radar device 400 may be configured to communicate radio signals according to an FMCW radar technology, e.g., rather than sending a radio transmit signal with a constant frequency.

In some demonstrative aspects, radio frontend 401 may be configured to ramp up and reset the frequency of the transmit signal, e.g., periodically, for example, according to a saw tooth waveform 403. In other aspects, a triangle waveform, or any other suitable waveform may be used.

In some demonstrative aspects, for example, radar processor 402 may be configured to provide waveform 403 to frontend 401, for example, in digital form, e.g., as a sequence of digital values.

In some demonstrative aspects, radar frontend 401 may include a DAC 404 to convert waveform 403 into analog form, and to supply it to a voltage-controlled oscillator 405. For example, oscillator 405 may be configured to generate an output signal, which may be frequency-modulated in accordance with the waveform 403.

In some demonstrative aspects, oscillator 405 may be configured to generate the output signal including a radio transmit signal, which may be fed to and sent out by one or more transmit antennas 406.

In some demonstrative aspects, the radio transmit signal generated by the oscillator 405 may have the form of a sequence of chirps 407, which may be the result of the modulation of a sinusoid with the saw tooth waveform 403.

In one example, a chirp 407 may correspond to the sinusoid of the oscillator signal frequency-modulated by a “tooth” of the saw tooth waveform 403, e.g., from the minimum frequency to the maximum frequency.

In some demonstrative aspects, a radar device may be configured to utilize radio transmit signals having a form of chirps, e.g., chirps 407, for example, according to a chirp modulation, e.g., as described below.

In other aspects, the radar device may be configured to utilize radio transmit signals configured according to a Phase Modulation (PM), a digital modulation, an OFDM modulation, and/or any other suitable type of modulation.

In some demonstrative aspects, FMCW radar device 400 may include one or more receive antennas 408 to receive a radio receive signal. The radio receive signal may be based on the echo of the radio transmit signal, e.g., in addition to any noise, interference, or the like.

In some demonstrative aspects, radar frontend 401 may include a mixer 409 to mix the radio transmit signal with the radio receive signal into a mixed signal.

In some demonstrative aspects, radar frontend 401 may include a filter, e.g., a Low Pass Filter (LPF) 410, which may be configured to filter the mixed signal from the mixer 409 to provide a filtered signal. For example, radar frontend 401 may include an ADC 411 to convert the filtered signal into digital reception data values, which may be provided to radar processor 402. In another example, the filter 410 may be a digital filter, and the ADC 411 may be arranged between the mixer 409 and the filter 410.

In some demonstrative aspects, radar processor 402 may be configured to process the digital reception data values to provide radar information, for example, including range, speed (velocity/Doppler), and/or direction (AoA) information of one or more objects.

In some demonstrative aspects, radar processor 402 may be configured to perform a first Fast Fourier Transform (FFT) (also referred to as “range FFT”) to extract a delay response, which may be used to extract range information, and/or a second FFT (also referred to as “Doppler FFT”) to extract a Doppler shift response, which may be used to extract velocity information, from the digital reception data values.

In other aspects, any other additional or alternative methods may be utilized to extract range information. In one example, in a digital radar implementation, a correlation with the transmitted signal may be used, e.g., according to a matched filter implementation.

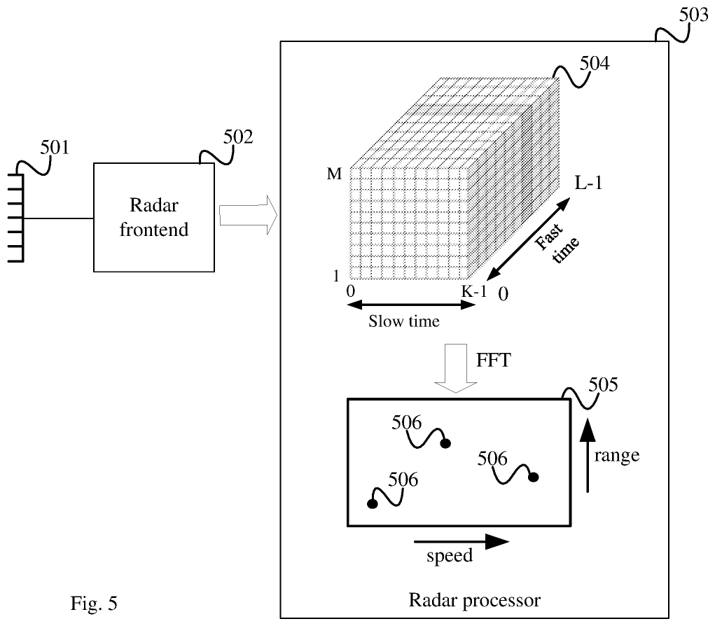

Reference is made to FIG. 5, which schematically illustrates an extraction scheme, which may be implemented to extract range and speed (Doppler) estimations from digital reception radar data values, in accordance with some demonstrative aspects. For example, radar processor 104 (FIG. 1), radar processor 210 (FIG. 2), radar processor 309 (FIG. 3), and/or radar processor 402 (FIG. 4), may be configured to extract range and/or speed (Doppler) estimations from digital reception radar data values according to one or more aspects of the extraction scheme of FIG. 5.

In some demonstrative aspects, as shown in FIG. 5, a radio receive signal, e.g., including echoes of a radio transmit signal, may be received by a receive antenna array 501. The radio receive signal may be processed by a radio radar frontend 502 to generate digital reception data values, e.g., as described above. The radio radar frontend 502 may provide the digital reception data values to a radar processor 503, which may process the digital reception data values to provide radar information, e.g., as described above.

In some demonstrative aspects, the digital reception data values may be represented in the form of a data cube 504. For example, the data cube 504 may include digitized samples of the radio receive signal, which is based on a radio signal transmitted from a transmit antenna and received by M receive antennas. In some demonstrative aspects, for example, with respect to a MIMO implementation, there may be multiple transmit antennas, and the number of samples may be multiplied accordingly.

In some demonstrative aspects, a layer of the data cube 504, for example, a horizontal layer of the data cube 504, may include samples of an antenna, e.g., a respective antenna of the M antennas.

In some demonstrative aspects, data cube 504 may include samples for K chirps. For example, as shown in FIG. 5, the samples of the chirps may be arranged in a so-called “slow time”-direction.

In some demonstrative aspects, the data cube 504 may include L samples, e.g., L=512 or any other number of samples, for a chirp, e.g., per each chirp. For example, as shown in FIG. 5, the samples per chirp may be arranged in a so-called “fast time”-direction of the data cube 504.

In some demonstrative aspects, processor 504 may be configured to determine the range values, Doppler values, and/or Angle of Arrival (AoA) values, e.g., Azimuth values and/or Elevation values, for example, based on FFT techniques, e.g., as described below.

In other aspects, processor 504 may be configured to determine the range values, Doppler values, and/or Angle of Arrival (AoA) values, e.g., Azimuth values and/or Elevation values, for example, based on Super-Resolution (SR) techniques, and/or any other suitable processing technique.

In some demonstrative aspects, radar processor 503 may be configured to process a plurality of samples, e.g., L samples collected for each chirp and for each antenna, by a first FFT. The first FFT may be performed, for example, for each chirp and each antenna, such that a result of the processing of the data cube 504 by the first FFT may again have three dimensions, and may have the size of the data cube 504 while including values for L range bins, e.g., instead of the values for the L sampling times.

In some demonstrative aspects, radar processor 503 may be configured to process the result of the processing of the data cube 504 by the first FFT, for example, by processing the result according to a second FFT along the chirps, e.g., for each antenna and for each range bin.

For example, the first FFT may be in the “fast time” direction, and the second FFT may be in the “slow time” direction.

In some demonstrative aspects, the result of the second FFT may provide, e.g., when aggregated over the antennas, a range/Doppler (R/D) map 505. The R/D map may have FFT peaks 506, for example, including peaks of FFT output values (in terms of absolute values) for certain range/speed combinations, e.g., for range/Doppler bins. For example, a range/Doppler bin may correspond to a range bin and a Doppler bin. For example, radar processor 503 may consider a peak as potentially corresponding to an object, e.g., of the range and speed corresponding to the peak's range bin and speed bin.

In some demonstrative aspects, the extraction scheme of FIG. 5 may be implemented for an FMCW radar, e.g., FMCW radar 400 (FIG. 4), as described above. In other aspects, the extraction scheme of FIG. 5 may be implemented for any other radar type. In one example, the radar processor 503 may be configured to determine a range/Doppler map 505 from digital reception data values of a PMCW radar, an OFDM radar, or any other radar technologies. For example, in adaptive or cognitive radar, the pulses in a frame, the waveform and/or modulation may be changed over time, e.g., according to the environment.

Referring back to FIG. 3, in some demonstrative aspects, receive antenna arrangement 303 may be implemented using a receive antenna array having a plurality of receive antennas (or receive antenna elements). For example, radar processor 309 may be configured to determine an angle of arrival of the received radio signal, e.g., echo 107 (FIG. 1) and/or echo 215 (FIG. 2). For example, radar processor 309 may be configured to determine a direction of a detected object, e.g., with respect to the device/system 301, for example, based on the angle of arrival of the received radio signal, e.g., as described below.

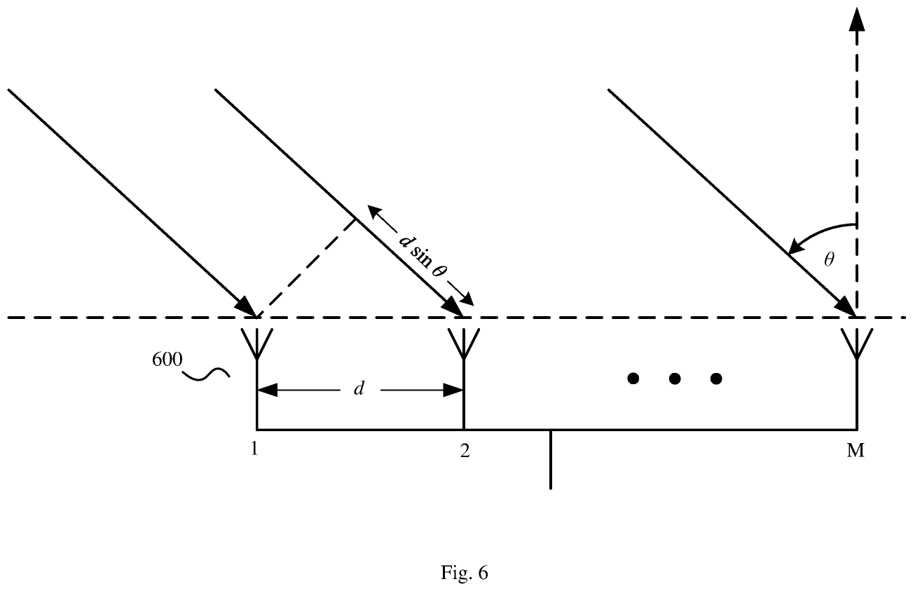

Reference is made to FIG. 6, which schematically illustrates an angle-determination scheme, which may be implemented to determine Angle of Arrival (AoA) information based on an incoming radio signal received by a receive antenna array 600, in accordance with some demonstrative aspects.

FIG. 6 depicts an angle-determination scheme based on received signals at the receive antenna array. In some demonstrative aspects, for example, in a virtual MIMO array, the angle-determination may also be based on the signals transmitted by the array of Tx antennas.

FIG. 6 depicts a one-dimensional angle-determination scheme. Other multi-dimensional angle determination schemes, e.g., a two-dimensional scheme or a three-dimensional scheme, may be implemented.

In some demonstrative aspects, as shown in FIG. 6, the receive antenna array 600 may include M antennas (numbered, from left to right, 1 to M).

As shown by the arrows in FIG. 6, it is assumed that an echo is coming from an object located at the top left direction. Accordingly, the direction of the echo, e.g., the incoming radio signal, may be towards the bottom right. According to this example, the further to the left a receive antenna is located, the earlier it will receive a certain phase of the incoming radio signal.

For example, a phase difference, denoted Δφ, between two antennas of the receive antenna array 600 may be determined, e.g., as follows:

$$\\ Δ φ = \frac{2 π}{λ} \cdot d \cdot sin ( θ )$$

wherein λ denotes a wavelength of the incoming radio signal, d denotes a distance between the two antennas, and θ denotes an angle of arrival of the incoming radio signal, e.g., with respect to a normal direction of the array.

In some demonstrative aspects, radar processor 309 (FIG. 3) may be configured to utilize this relationship between phase and angle of the incoming radio signal, for example, to determine the angle of arrival of echoes, for example by performing an FFT, e.g., a third FFT (“angular FFT”) over the antennas.

In some demonstrative aspects, multiple transmit antennas, e.g., in the form of an antenna array having multiple transmit antennas, may be used, for example, to increase the spatial resolution, e.g., to provide high-resolution radar information. For example, a MIMO radar device may utilize a virtual MIMO radar antenna, which may be formed as a convolution of a plurality of transmit antennas convolved with a plurality of receive antennas.

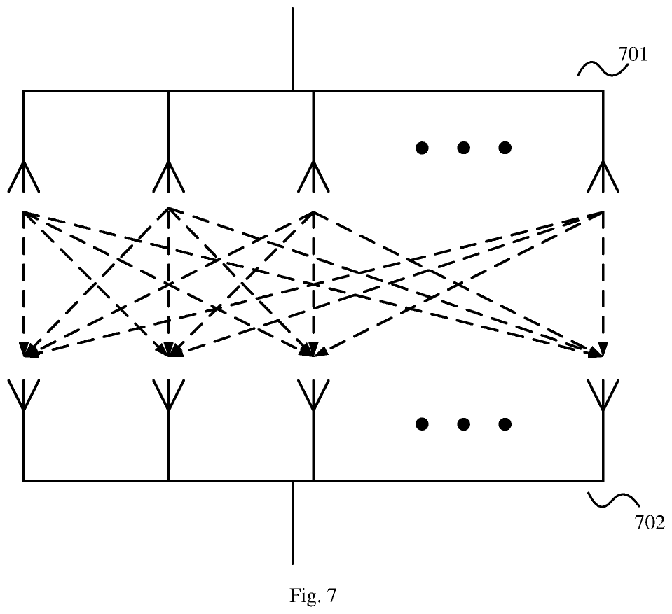

Reference is made to FIG. 7, which schematically illustrates a MIMO radar antenna scheme, which may be implemented based on a combination of Transmit (Tx) and Receive (Rx) antennas, in accordance with some demonstrative aspects.

In some demonstrative aspects, as shown in FIG. 7, a radar MIMO arrangement may include a transmit antenna array 701 and a receive antenna array 702. For example, the one or more transmit antennas 302 (FIG. 3) may be implemented to include transmit antenna array 701, and/or the one or more receive antennas 303 (FIG. 3) may be implemented to include receive antenna array 702.

In some demonstrative aspects, antenna arrays including multiple antennas both for transmitting the radio transmit signals and for receiving echoes of the radio transmit signals, may be utilized to provide a plurality of virtual channels as illustrated by the dashed lines in FIG. 7. For example, a virtual channel may be formed as a convolution, for example, as a Kronecker product, between a transmit antenna and a receive antenna, e.g., representing a virtual steering vector of the MIMO radar.

In some demonstrative aspects, a transmit antenna, e.g., each transmit antenna, may be configured to send out an individual radio transmit signal, e.g., having a phase associated with the respective transmit antenna.

For example, an array of N transmit antennas and M receive antennas may be implemented to provide a virtual MIMO array of size N×M. For example, the virtual MIMO array may be formed according to the Kronecker product operation applied to the Tx and Rx steering vectors.

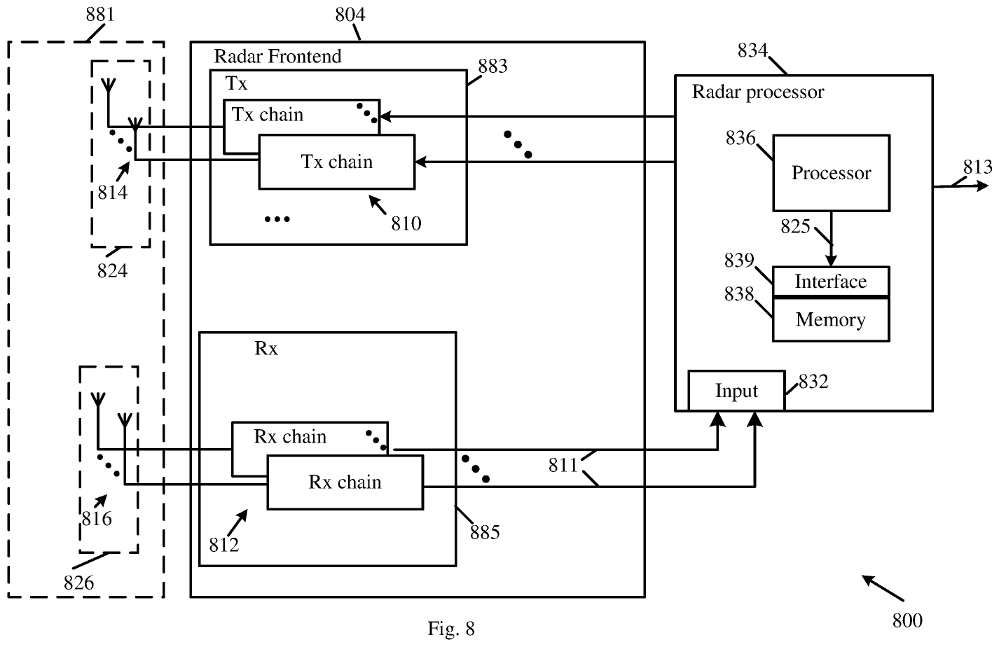

FIG. 8 is a schematic block diagram illustration of elements of a radar device 800, in accordance with some demonstrative aspects. For example, radar device 101 (FIG. 1), radar device 300 (FIG. 3), and/or radar device 400 (FIG. 4), may include one or more elements of radar device 800, and/or may perform one or more operations and/or functionalities of radar device 800.

In some demonstrative aspects, as shown in FIG. 8, radar device 800 may include a radar frontend 804 and a radar processor 834. For example, radar frontend 103 (FIG. 1), radar frontend 211 (FIG. 1), radar frontend 304 (FIG. 3), radar frontend 401 (FIG. 4), and/or radar frontend 502 (FIG. 5), may include one or more elements of radar frontend 804, and/or may perform one or more operations and/or functionalities of radar frontend 804.

In some demonstrative aspects, radar frontend 804 may be implemented as part of a MIMO radar utilizing a MIMO radar antenna 881 including a plurality of Tx antennas 814 configured to transmit a plurality of Tx RF signals (also referred to as “Tx radar signals”); and a plurality of Rx antennas 816 configured to receive a plurality of Rx RF signals (also referred to as “Rx radar signals”), for example, based on the Tx radar signals, e.g., as described below.

In some demonstrative aspects, MIMO antenna array 881, antennas 814, and/or antennas 816 may include or may be part of any type of antennas suitable for transmitting and/or receiving radar signals. For example, MIMO antenna array 881, antennas 814, and/or antennas 816, may be implemented as part of any suitable configuration, structure, and/or arrangement of one or more antenna elements, components, units, assemblies, and/or arrays. For example, MIMO antenna array 881, antennas 814, and/or antennas 816, may be implemented as part of a phased array antenna, a multiple element antenna, a set of switched beam antennas, and/or the like. In some aspects, MIMO antenna array 881, antennas 814, and/or antennas 816, may be implemented to support transmit and receive functionalities using separate transmit and receive antenna elements. In some aspects, MIMO antenna array 881, antennas 814, and/or antennas 816, may be implemented to support transmit and receive functionalities using common and/or integrated transmit/receive elements.

In some demonstrative aspects, MIMO radar antenna 881 may include a rectangular MIMO antenna array, and/or curved array, e.g., shaped to fit a vehicle design. In other aspects, any other form, shape and/or arrangement of MIMO radar antenna 881 may be implemented.

In some demonstrative aspects, radar frontend 804 may include one or more radios configured to generate and transmit the Tx RF signals via Tx antennas 814; and/or to process the Rx RF signals received via Rx antennas 816, e.g., as described below.

In some demonstrative aspects, radar frontend 804 may include at least one transmitter (Tx) 883 including circuitry and/or logic configured to generate and/or transmit the Tx radar signals via Tx antennas 814.

In some demonstrative aspects, radar frontend 804 may include at least one receiver (Rx) 885 including circuitry and/or logic to receive and/or process the Rx radar signals received via Rx antennas 816, for example, based on the Tx radar signals.

In some demonstrative aspects, transmitter 883, and/or receiver 885 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like.

In some demonstrative aspects, transmitter 883 may include a plurality of Tx chains 810 configured to generate and transmit the Tx RF signals via Tx antennas 814, e.g., respectively; and/or receiver 885 may include a plurality of Rx chains 812 configured to receive and process the Rx RF signals received via the Rx antennas 816, e.g., respectively.

In some demonstrative aspects, radar processor 834 may be configured to generate radar information 813, for example, based on the radar signals communicated by MIMO radar antenna 881, e.g., as described below. For example, radar processor 104 (FIG. 1), radar processor 210 (FIG. 2), radar processor 309 (FIG. 3), radar processor 402 (FIG. 4), and/or radar processor 503 (FIG. 5), may include one or more elements of radar processor 834, and/or may perform one or more operations and/or functionalities of radar processor 834.

In some demonstrative aspects, radar processor 834 may be configured to generate radar information 813, for example, based on radar Rx data 811 received from the plurality of Rx chains 812. For example, radar Rx data 811 may be based on the radar Rx signals received via the Rx antennas 816.

In some demonstrative aspects, radar processor 834 may include an input 832 to receive radar input data, e.g., including the radar Rx data 811 from the plurality of Rx chains 812.

In some demonstrative aspects, radar processor 834 may include, or may be implemented, partially or entirely, by circuitry and/or logic, e.g., one or more processors including circuitry and/or logic, memory circuitry and/or logic. Additionally or alternatively, one or more functionalities of radar processor 834 may be implemented by logic, which may be executed by a machine and/or one or more processors, e.g., as described below.

In some demonstrative aspects, radar processor 834 may include at least one processor 836, which may be configured, for example, to process the radar Rx data 811, and/or to perform one or more operations, methods, and/or algorithms.

In some demonstrative aspects, radar processor 834 may include at least one memory 838, e.g., coupled to the processor 836. For example, memory 838 may be configured to store data processed by radar processor 834. For example, memory 838 may store, e.g., at least temporarily, at least some of the information processed by the processor 836, and/or logic to be utilized by the processor 836.

In some demonstrative aspects, processor 836 may interface with memory 838, for example, via a memory interface 839.

In some demonstrative aspects, processor 836 may be configured to access memory 838, e.g., to write data to memory 838 and/or to read data from memory 838, for example, via memory interface 839.

In some demonstrative aspects, memory 838 may be configured to store at least part of the radar data, e.g., some of the radar Rx data or all of the radar Rx data, for example, for processing by processor 836, e.g., as described below.

In some demonstrative aspects, memory 838 may be configured to store processed data, which may be generated by processor 836, for example, during the process of generating the radar information 813, e.g., as described below.

In some demonstrative aspects, memory 838 may be configured to store range information and/or Doppler information, which may be generated by processor 836, for example, based on the radar Rx data. In one example, the range information and/or Doppler information may be determined based on a Cross-Correlation (XCORR) operation, which may be applied to the radar Rx data. Any other additional or alternative operation, algorithm and/or procedure may be utilized to generate the range information and/or Doppler information.

In some demonstrative aspects, memory 838 may be configured to store AoA information, which may be generated by processor 836, for example, based on the radar Rx data, the range information and/or Doppler information. In one example, the AoA information may be determined based on an AoA estimation algorithm. Any other additional or alternative operation, algorithm and/or procedure may be utilized to generate the AoA information.

In some demonstrative aspects, radar processor 834 may be configured to generate the radar information 813 including one or more of range information, Doppler information, and/or AoA information.

In some demonstrative aspects, the radar information 813 may include Point Cloud 1 (PC1) information, for example, including raw point cloud estimations, e.g., Range, Radial Velocity, Azimuth and/or Elevation.

In some demonstrative aspects, the radar information 813 may include Point Cloud 2 (PC2) information, which may be generated, for example, based on the PC1 information. For example, the PC2 information may include clustering information, tracking information, e.g., tracking of probabilities and/or density functions, bounding box information, classification information, orientation information, and the like.

In some demonstrative aspects, the radar information 813 may include target tracking information corresponding to a plurality of targets in an environment of the radar device 800, e.g., as described below.

In some demonstrative aspects, radar processor 834 may be configured to generate the radar information 813 in the form of four Dimensional (4D) image information, e.g., a cube, which may represent 4D information corresponding to one or more detected targets.

In some demonstrative aspects, the 4D image information may include, for example, range values, e.g., based on the range information, velocity values, e.g., based on the Doppler information, azimuth values, e.g., based on azimuth AoA information, elevation values, e.g., based on elevation AoA information, and/or any other values.

In some demonstrative aspects, radar processor 834 may be configured to generate the radar information 813 in any other form, and/or including any other additional or alternative information.

In some demonstrative aspects, radar processor 834 may be configured to process the signals communicated via MIMO radar antenna 881 as signals of a virtual MIMO array formed by a convolution of the plurality of Rx antennas 816 and the plurality of Tx antennas 814.

In some demonstrative aspects, radar frontend 804 and/or radar processor 834 may be configured to utilize MIMO techniques, for example, to support a reduced physical array aperture, e.g., an array size, and/or utilizing a reduced number of antenna elements. For example, radar frontend 804 and/or radar processor 834 may be configured to transmit orthogonal signals via one or more Tx arrays 824 including a plurality of N elements, e.g., Tx antennas 814, and processing received signals via one or more Rx arrays 826 including a plurality of M elements, e.g., Rx antennas 816.

In some demonstrative aspects, utilizing the MIMO technique of transmission of the orthogonal signals from the Tx arrays 824 with N elements and processing the received signals in the Rx arrays 826 with M elements may be equivalent, e.g., under a far field approximation, to a radar utilizing transmission from one antenna and reception with N*M antennas. For example, radar frontend 804 and/or radar processor 834 may be configured to utilize MIMO antenna array 881 as a virtual array having an equivalent array size of N*M, which may define locations of virtual elements, for example, as a convolution of locations of physical elements, e.g., the antennas 814 and/or 816.

In some demonstrative aspects, a radar system may include a plurality of radar devices 800. For example, vehicle 100 (FIG. 1) may include a plurality of radar devices 800, e.g., as described below.

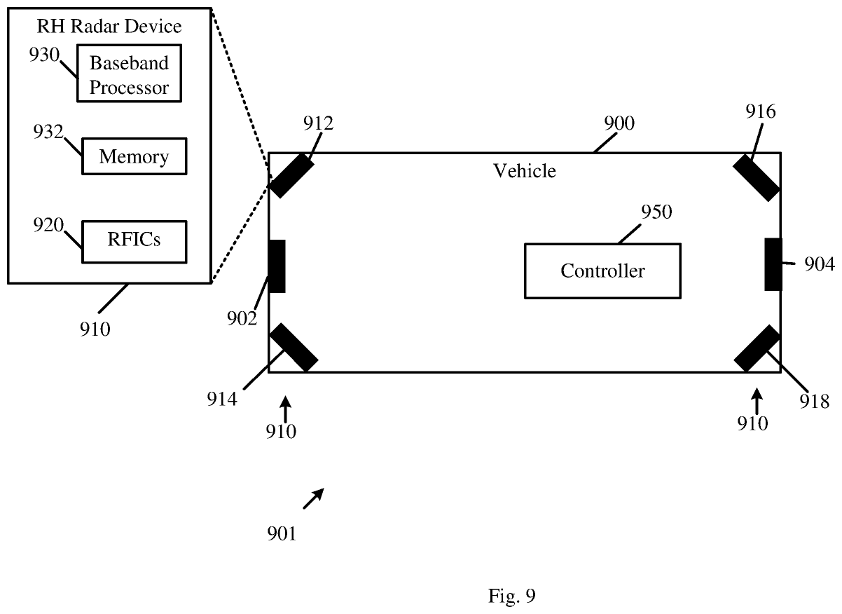

Reference is made to FIG. 9, which schematically illustrates a radar system 901 including a plurality of Radio Head (RH) radar devices (also referred to as RHs) 910 implemented in a vehicle 900, in accordance with some demonstrative aspects.

In some demonstrative aspects, as shown in FIG. 9, the plurality of RH radar devices 910 may be located, for example, at a plurality of positions around vehicle 900, for example, to provide radar sensing at a large field of view around vehicle 900, e.g., as described below.

In some demonstrative aspects, as shown in FIG. 9, the plurality of RH radar devices 910 may include, for example, six RH radar devices 910, e.g., as described below.

In some demonstrative aspects, the plurality of RH radar devices 910 may be located, for example, at a plurality of positions around vehicle 900, which may be configured to support 360-degrees radar sensing, e.g., a field of view of 360 degrees surrounding the vehicle 900, e.g., as described below.

In one example, the 360-degrees radar sensing may allow to provide a radar-based view of substantially all surroundings around vehicle 900, e.g., as described below.

In other aspects, the plurality of RH radar devices 910 may include any other number of RH radar devices 910, e.g., less than six radar devices or more than six radar devices.

In other aspects, the plurality of RH radar devices 910 may be positioned at any other locations and/or according to any other arrangement, which may support radar sensing at any other field of view around vehicle 900, e.g., 360-degrees radar sensing or radar sensing of any other field of view.

In some demonstrative aspects, as shown in FIG. 9, vehicle 900 may include a first RH radar device 902, e.g., a front RH, at a front-side of vehicle 900.

In some demonstrative aspects, as shown in FIG. 9, vehicle 900 may include a second RH radar device 904, e.g., a back RH, at a back-side of vehicle 900.

In some demonstrative aspects, as shown in FIG. 9, vehicle 900 may include one or more of RH radar devices at one or more respective corners of vehicle 900. For example, vehicle 900 may include a first corner RH radar device 912 at a first corner of vehicle 900, a second corner RH radar device 914 at a second corner of vehicle 900, a third corner RH radar device 916 at a third corner of vehicle 900, and/or a fourth corner RH radar device 918 at a fourth corner of vehicle 900.

In some demonstrative aspects, vehicle 900 may include one, some, or all, of the plurality of RH radar devices 910 shown in FIG. 9. For example, vehicle 900 may include the front RH radar device 902 and/or back RH radar device 904.

In other aspects, vehicle 900 may include any other additional or alternative radar devices, for example, at any other additional or alternative positions around vehicle 900. In one example, vehicle 900 may include a side radar, e.g., on a side of vehicle 900.

In some demonstrative aspects, as shown in FIG. 9, vehicle 900 may include a radar system controller 950 configured to control one or more, e.g., some or all, of the RH radar devices 910.

In some demonstrative aspects, at least part of the functionality of radar system controller 950 may be implemented by a dedicated controller, e.g., a dedicated system controller or central controller, which may be separate from the RH radar devices 910, and may be configured to control some or all of the RH radar devices 910.

In some demonstrative aspects, at least part of the functionality of radar system controller 950 may be implemented as part of at least one RH radar device 910.

In some demonstrative aspects, at least part of the functionality of radar system controller 950 may be implemented by a radar processor of an RH radar device 910. For example, radar processor 834 (FIG. 8) may include one or more elements of radar system controller 950, and/or may perform one or more operations and/or functionalities of radar system controller 950.

In some demonstrative aspects, at least part of the functionality of radar system controller 950 may be implemented by a system controller of vehicle 900. For example, vehicle controller 108 (FIG. 1) may include one or more elements of radar system controller 950, and/or may perform one or more operations and/or functionalities of radar system controller 950.

In other aspects, one or more functionalities of system controller 950 may be implemented as part of any other element of vehicle 900.

In some demonstrative aspects, as shown in FIG. 9, an RH radar device 910 of the plurality of RH radar devices 910, may include a baseband processor 930 (also referred to as a “Baseband Processing Unit (BPU)”), which may be configured to control communication of radar signals by the RH radar device 910, and/or to process radar signals communicated by the RH radar device 910. For example, baseband processor 930 may include one or more elements of radar processor 834 (FIG. 8), and/or may perform one or more operations and/or functionalities of radar processor 834 (FIG. 8).

In other aspects, an RH radar device 910 of the plurality of RH radar devices 910 may exclude one or more, e.g., some or all, functionalities of baseband processor 930. For example, controller 950 may be configured to perform one or more, e.g., some or all, functionalities of the baseband processor 930 for the RH.

In one example, controller 950 may be configured to perform baseband processing for all RH radar devices 910, and all RH radio devices 910 may be implemented without baseband processors 930.

In another example, controller 950 may be configured to perform baseband processing for one or more first RH radar devices 910, and the one or more first RH radio devices 910 may be implemented without baseband processors 930; and/or one or more second RH radar devices 910 may be implemented with one or more functionalities, e.g., some or all functionalities, of baseband processors 930.

In another example, one or more, e.g., some or all, RH radar devices 910 may be implemented with one or more functionalities, e.g., partial functionalities or full functionalities, of baseband processors 930.

In some demonstrative aspects, baseband processor 930 may include one or more components and/or elements configured for digital processing of radar signals communicated by the RH radar device 910, e.g., as described below.

In some demonstrative aspects, baseband processor 930 may include one or more FFT engines, matrix multiplication engines, DSP processors, and/or any other additional or alternative baseband, e.g., digital, processing components.

In some demonstrative aspects, as shown in FIG. 9, RH radar device 910 may include a memory 932, which may be configured to store data processed by, and/or to be processed by, baseband processor 930. For example, memory 932 may include one or more elements of memory 838 (FIG. 8), and/or may perform one or more operations and/or functionalities of memory 838 (FIG. 8).

In some demonstrative aspects, memory 932 may include an internal memory, and/or an interface to one or more external memories, e.g., an external Double Data Rate (DDR) memory, and/or any other type of memory.

In other aspects, an RH radar device 910 of the plurality of RH radar devices 910 may exclude memory 932. For example, the RH radar device 910 may be configured to provide radar data to controller 950, e.g., in the form of raw radar data.

In some demonstrative aspects, as shown in FIG. 9, RH radar device 910 may include one or more RF units, e.g., in the form of one or more RF Integrated Chips (RFICs) 920, which may be configured to communicate radar signals, e.g., as described below.

For example, an RFIC 920 may include one or more elements of front-end 804 (FIG. 8), and/or may perform one or more operations and/or functionalities of front-end 804 (FIG. 8).

In some demonstrative aspects, the plurality of RFICs 920 may be operable to form a radar antenna array including one or more Tx antenna arrays and one or more Rx antenna arrays.

For example, the plurality of RFICs 920 may be operable to form MIMO radar antenna 881 (FIG. 8) including Tx arrays 824 (FIG. 8), and/or Rx arrays 826 (FIG. 8).

In some demonstrative aspects, the plurality of RFICs 920 may be operable to form a MIMO radar antenna, for example, including one or more Tx antenna arrays and one or more Rx antenna arrays.

In some demonstrative aspects, a radar device, e.g., as described above with reference to FIGS. 1-9, may be configured to implement radar communications according to a MIMO scheme utilizing a MIMO radar antenna, e.g., as described below.

For example, radar antenna 881 (FIG. 8) may include a MIMO radar antenna, which may include one or more Tx arrays 824 (FIG. 8), and one or more Rx arrays 826 (FIG. 8).

In some demonstrative aspects, the MIMO radar antenna may be implemented for communication of radar signals according to a MIMO scheme, e.g., as described below.

For example, in a beamforming system, e.g., without loss of generativity, assuming a system including a single transmitter and multiple receivers, e.g., a Single Input Multiple Output (SIMO) system, a number of Rx antennas may be doubled, for example, in order to double an angular resolution of the SIMO system, e.g., to achieve a half resolution bin. For example, in a MIMO system, the same result may be achieved, for example, with a double number of Tx antennas.

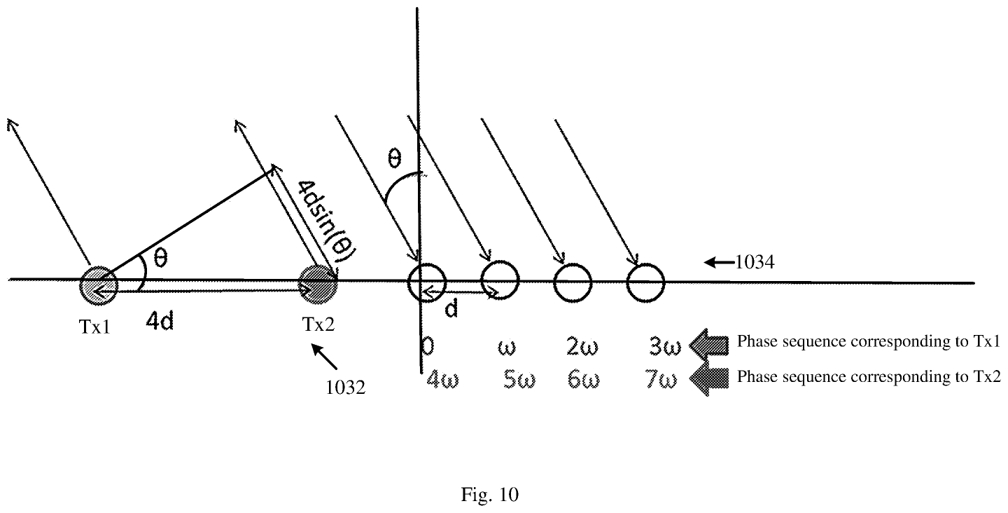

Reference is made to FIG. 10, which schematically illustrates signals of a 2×4 MIMO antenna array 1000, which may be implemented in accordance with some demonstrative aspects.

For example, MIMO radar antenna 881 (FIG. 8) may include one or more elements of 2×4 MIMO antenna array 1000, and/or may perform the functionality of 2×4 MIMO antenna array 1000.

For example, as shown in FIG. 10, the 2×4 MIMO antenna array 1000 may include two Tx antennas 1032, for example, including a first Tx antenna 1032, denoted Tx1, and a second Tx antenna 1032, denoted Tx2.

For example, as shown in FIG. 10, the 2×4 MIMO antenna array 1000 may include four Rx antennas 1034.

For example, in the 2×4 MIMO system 1000, a first transmission from the first antenna Tx1 may result in a first set of phases of [0 ω 2ω 3ω] at the four Rx antennas 1034, respectively, e.g., with a first Rx antenna 1034 serving as a reference.

For example, in the 2×4 MIMO system 1000, a second transmission from the second antenna Tx2 may result in a second set of phases of [4ω 5ω 6ω 7ω] at the four Rx antennas 1034, respectively, e.g., with the first Rx antenna 1034 serving as a reference.

For example, the second Tx antenna Tx2 may be placed at a distance of 4d from the first Tx antenna Tx1, e.g., wherein d denotes a distance between consecutive Rx antennas 1034. According to this example, a signal, e.g., any signal, emanating from the second Tx antenna Tx2 may traverse an additional path having a length 4d sin(θ), e.g., compared to a signal from the first antenna Tx1. Correspondingly, a signal at an Rx antenna 1034, e.g., a signal at each Rx antenna 1034, may see an additional phase-shift of 4ω, for example, with regard to a signal from the first antenna Tx1 received at the same Rx antenna 1034.

For example, the phase of the signal at the four Rx antennas 1034, e.g., due to the second transmission from the second antenna Tx2, may be represented by the set of phases [4ω 5ω 6ω 7ω].

For example, concatenating the phase sequences at the four Rx antennas 1034, e.g., corresponding to transmissions from the first antenna Tx1 and the second antenna Tx2, may result in a sequence of phases [0 ω 2ω 3ω 4ω 5ω 6ω 7ω].

For example, the sequence of phases [0 ω 2ω 3ω 4ω 5ω 6ω 7ω] may be the same as a sequence of phases seen by a 1×8 SIMO system.

For example, it can be said that the 2×4 MIMO system 1000 may synthesize a virtual array of eight Rx antennas and one Tx antenna implied.

For example, with an antenna array including N_{Tx} transmit antennas and N_{Rx} receive antennas, one can generate, e.g., while utilizing proper antenna placement, a virtual antenna array of N_{Tx}×N_{Rx} virtual antennas.

For example, MIMO radar techniques may be employed, for example, to provide a technical solution to support an increase, e.g., a multiplicative increase, in a number of virtual antennas.

For example, the increased number of virtual antennas may be implemented to provide a technical solution to support an improvement in an angular resolution.

For example, using pₘ to denote coordinates of an m-th Tx antenna (m=0, 1, . . . . N_{Tx}), and using qₙ to denote coordinates of an n-th Rx antenna (n=0, 1, 2, . . . . N_{Rx}), a location of a virtual antenna, based on the m-th Tx antenna and the n-th Rx antenna, may be computed as pₘ+qₙ, e.g., for all possible values of m and n.

For example, the locations of the virtual antennas may be represented in a compact form, e.g., as follows:

$$\\ r = p ⊗ q$$

wherein r denotes coordinates of the elements in the virtual array, which is a result of a convolution of coordinates of the m-th Tx and the n-th Rx array elements.

In some demonstrative aspects, a radar device, e.g., as described above with reference to FIGS. 1-10, may be configured to implement a radar antenna array, e.g., a MIMO radar antenna array, which may be configured to provide a virtual array (also referred to as “overlapped virtual antenna array”) having an overlapped virtual array geometry, e.g., as described below.

In some demonstrative aspects, the overlapped virtual antenna array may be configured to provide a technical solution to support improved multi-path mitigation and/or one or more additional or alternative technical benefits.

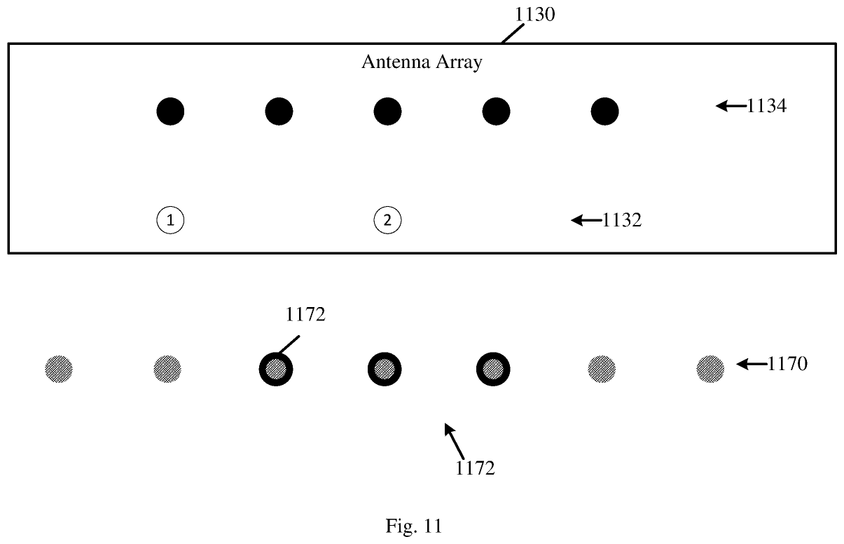

Reference is made to FIG. 11, which schematically illustrates an antenna array (“physical antenna array”) 1130 and an overlapped virtual antenna array 1170 based on the antenna array 1130, which may be implemented in accordance with some demonstrative aspects.

For example, MIMO radar antenna 881 (FIG. 8) may include one or more elements of antenna array 1130, and/or may perform the functionality of antenna array 1130.

As shown in FIG. 11, antenna array 1130 may include a 2×5 MIMO antenna array.

For example, as shown in FIG. 11, antenna array 1130 may include five Rx antennas 1134 arranged along an Rx array, and two Tx antennas 1132, e.g., including a first Tx antenna (1) and a second Tx antenna (2).

For example, as shown in FIG. 11, a distance between the first Tx antenna (1) and the second Tx antenna (2) may be shorter than a length of the Rx array.

In other aspects, antenna array 1130 may include any other count of Tx antenna elements, any other count of Rx antenna elements, and/or any other arrangement of the Tx antenna elements and/or the Rx antenna elements.

In some demonstrative aspects, overlapped virtual antenna array 1170 may include one or more sets 1172 of overlapped virtual antennas (antenna elements), which may have substantially overlapping locations.

For example, as shown in FIG. 11, virtual antenna array 1170 may include three sets 1172 of overlapped virtual antennas.

For example, a set 1172 of overlapped virtual antennas may include a plurality of substantially overlapping virtual antennas, e.g., at substantially a same virtual location.

For example, a set 1172 of overlapped antennas may include a first virtual antenna, which may be based on a combination of the first Tx antenna (1) and a first Rx antenna 1134, and a second virtual antenna, which may be based on a combination of the second Tx antenna (2) and a second Rx antenna 1134.

In some demonstrative aspects, a radar device, e.g., as described above with reference to FIGS. 1-11, may be configured to implement one or more operations and/or functionalities of a radar processing mechanism, which may be configured to provide a technical solution to support a Doppler ambiguity estimation, for example, for a MIMO radar, e.g., as described below.

In some demonstrative aspects, in some use cases and/or scenarios, implementation of a relatively low Pulse Repetition Interval (PRI) may result in Doppler ambiguity, e.g., as described below.

In some demonstrative aspects, in some use cases and/or scenarios, targets having a high velocity, e.g., relative to a PRI implemented by a MIMO radar, may lead to a Doppler ambiguity, which may impair a radar detection performance.

In some demonstrative aspects, for example, in some use cases and/or scenarios, it may be disadvantageous to implement an azimuth/elevation spectrum, which may be focused for Doppler ambiguity estimation. For example, the azimuth/elevation spectrum may not be mathematically defined and/or may have a worse performance, for example, in case of a sparse elevation array, and/or in case when there are many Doppler ambiguity folds to resolve.

In some demonstrative aspects, a radar device, e.g., as described above with reference to FIGS. 1-11, may be configured to implement one or more operations and/or functionalities of a radar processing mechanism, which may be configured to support Doppler fold estimation, e.g., as described below.

In some demonstrative aspects, the radar processing mechanism may be configured to provide a technical solution to support improved performance, for example, to support implementations utilizing a nonlinear virtual array, e.g., in an elevation dimension.

In some demonstrative aspects, the radar processing mechanism may be configured to provide a technical solution to resolve multiple Doppler ambiguity folds, for example, with a relatively low fold error, e.g., as described below.

In some demonstrative aspects, the radar processing mechanism may be implemented, for example, using an overlapped virtual array, for example, overlapped virtual antenna array 1170 (FIG. 11), e.g., as described below.

In some demonstrative aspects, the radar processing mechanism may be configured to use signals of one or more sets of overlapped antennas, e.g., overlapped sets 1172 (FIG. 11) of overlapped virtual antenna array 1170 (FIG. 11), for example, to estimate a phase jump between Tx antennas that transmit inside a single slow time slot, for example, to resolve a Doppler ambiguity fold, e.g., as described below.

In some demonstrative aspects, the radar processing mechanism may be implemented, for example, using an overlapped virtual array, e.g., as described above.

In other aspects, the radar processing mechanism may be implemented, for example, even in case a non-overlapped virtual array is implemented.

In some demonstrative aspects, the radar processing mechanism may be configured to utilize a Tx codebook design, which may be applied for transmission of the Tx radar signals, e.g., as described below. For example, the Tx codebook design may be configured to provide a technical solution, e.g., an optimal solution, which may support a Doppler ambiguity estimation, for example, based on a closed form mathematical model, for example, for Compressed Time Division Multiplexing (CTDM) signals, e.g., as described below.

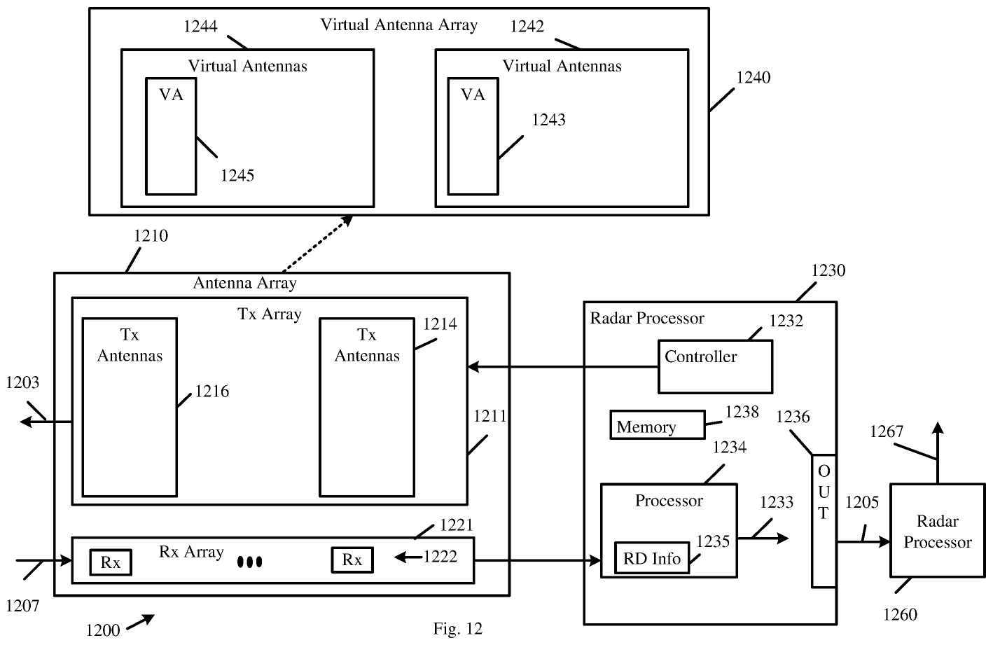

Reference is made to FIG. 12, which schematically illustrates a system 1200, in accordance with some demonstrative aspects.

In some demonstrative aspects, one or more elements of the system 1200 may be implemented by a radar device, e.g., radar device 800 (FIG. 8) or radar device 910 (FIG. 9), and/or a radar system, e.g., radar system 901 (FIG. 9).

In some demonstrative aspects, one or more elements of system 1200 may be configured to implement one or more operations and/or functionalities of a radar processing mechanism, e.g., as described below.

In some demonstrative aspects, one or more elements of system 1200 may be configured to implement one or more operations and/or functionalities of a radar processing mechanism, which may be configure, for example, to resolve a Doppler ambiguity, e.g., as described below.

In some demonstrative aspects, system 1200 may include an antenna array 1210, e.g., as described below. For example, MIMO antenna array 881 (FIG. 8) may include one or more elements of antenna array 1210, and/or may perform one or more operations and/or functionalities of antenna array 1210.

In some demonstrative aspects, as shown in FIG. 12, antenna array 1210 may include a Tx array 1211 to transmit radar Tx signals 1203, e.g., as described below.

In some demonstrative aspects, Tx array 1211 may include a first plurality of Tx antennas 1214 and a second plurality of Tx antennas 1216, e.g., as described below.

In some demonstrative aspects, as shown in FIG. 12, the first plurality of Tx antennas 1214 may include a first column of Tx antennas, e.g., as described below.

In some demonstrative aspects, as shown in FIG. 12, the second plurality of Tx antennas 1216 may include a second column of Tx antennas, e.g., as described below.

In other aspects, the first plurality of Tx antennas 1214 and/or the second plurality of Tx antennas 1216 may be arranged according to any other suitable arrangement of columns, rows, and/or any other array arrangement.

In some demonstrative aspects, as shown in FIG. 12, antenna array 1210 may include an Rx antenna array 1221 including a plurality of Rx antennas 1222, e.g., as described below.

In some demonstrative aspects, as shown in FIG. 12, the plurality of Rx antennas 1222 may be configured to receive radar Rx signals 1207, for example, based on the radar Tx signals 1203 from Tx array 1211, e.g., as described below.

In some demonstrative aspects, as shown in FIG. 12, the plurality of Rx antennas 1222 may include a row of Rx antennas, e.g., as described below.

In other aspects, the plurality of Rx antennas 1222 may be arranged in more than one row, and/or according to any other suitable arrangement of columns, rows, and/or any other array arrangement.

In some demonstrative aspects, as shown in FIG. 12, system 1200 may include a radar processor 1230, e.g., as described below.

In some demonstrative aspects, radar processor 1230 may be implemented, for example, as part of a radar device, e.g., a radar device 910 (FIG. 9).

In some demonstrative aspects, radar processor 1230 may be implemented, for example, as part of a radar processor, e.g., radar processor 834 (FIG. 8), and/or BB processor 930 (FIG. 9).

For example, radar processor 834 (FIG. 8) may include one or more elements of radar processor 1230, and/or may perform one or more operations and/or functionalities of radar processor 1230.

In some demonstrative aspects, radar processor 1230 may include a processor 1234. For example, radar processor 834 (FIG. 8) may include one or more elements of processor 1234, and/or may perform one or more operations and/or functionalities of processor 1234; and/or BB processor 930 (FIG. 9) may include one or more elements of processor 1234, and/or may perform one or more operations and/or functionalities of processor 1234.

In some demonstrative aspects, processor 1234 may include, or may be implemented, partially or entirely, by circuitry and/or logic, e.g., one or more processors including circuitry and/or logic, memory circuitry and/or logic. Additionally or alternatively, one or more functionalities of processor 1234 may be implemented by logic, which may be executed by a machine and/or one or more processors, e.g., as described below.

In other aspects, processor 1234 may be implemented as part of any other, dedicated, or non-dedicated, element of a radar device, e.g., radar device 800 (FIG. 8) or radar device 910 (FIG. 9), and/or a radar system, e.g., radar system 901 (FIG. 9).

In some demonstrative aspects, processor 1234 may be configured to process Range-Doppler (RD) information 1235 corresponding to an RD bin, e.g., as described below.

In some demonstrative aspects, the RD information 1235 corresponding to the RD bin may be based, for example, on the radar Rx signals 1207 received by the plurality of Rx antennas 1222, e.g., as described below.

In some demonstrative aspects, the radar Rx signals 1207 received by the plurality of Rx antennas 1222 may be based, for example, on the radar Tx signals from the Tx array 1211 including the first plurality of Tx antennas 1214 and the second plurality of Tx antennas 1216, e.g., as described below.

In some demonstrative aspects, processor 1234 may be configured to process the RD information 1235 corresponding to the RD bin, for example, to identify a first plurality of values corresponding to a first plurality of virtual antennas 1242 of a virtual antenna array 1240, and a second plurality of values corresponding to a second plurality of virtual antennas 1244 of the virtual antenna array 1240, e.g., as described below.

In some demonstrative aspects, the virtual antenna array 1240 may be based on antenna array 1210, e.g., as described below.

In some demonstrative aspects, the first plurality of virtual antennas 1242 may be based, for example, on the plurality of Rx antennas 1222 and the first plurality of Tx antennas 1214, e.g., as described below.

In some demonstrative aspects, the second plurality of virtual antennas 1244 may be based, for example, on the plurality of Rx antennas 1222 and the second plurality of Tx antennas 1216, e.g., as described below.

In some demonstrative aspects, processor 1234 may be configured to determine one or more estimated RD-Azimuth (RDAz) based (RDAz-based) Doppler folds 1233 corresponding to one or more RDAz bins, for example, based on the first plurality of values and the second plurality of values, e.g., as described below.

In some demonstrative aspects, radar processor 1230 may include an output 1236, which may be configured to provide processed data 1205, for example, based on the one or more estimated RDAz-based Doppler folds 1233, e.g., as described below.

In some demonstrative aspects, processor 1234 may be configured to provide the processed data 1205, for example, to include Doppler fold information, for example, to indicate the one or more estimated RDAz-based Doppler folds 1233, e.g., as described below.

In some demonstrative aspects, processor 1234 may be configured to provide the processed data 1205, for example, to include processed radar data corresponding to the one or more RDAz bins, e.g., as described below.

In some demonstrative aspects, processor 1234 may be configured to provide the processed data 1205, for example, to include the Doppler fold information, for example, including the one or more estimated RDAz-based Doppler folds 1233 corresponding to the one or more RDAz bins, e.g., as described below.

In some demonstrative aspects, processor 1234 may be configured to determine an estimated Doppler value for a target in an RDAz bin, for example, based on a sum of a Doppler value corresponding to the RD bin and an estimated RDAz-based Doppler fold 1233 corresponding to the RDAz bin, e.g., as described below.

In some demonstrative aspects, processor 1234 may be configured to generate the processed data 1205, which may be based, for example, on the estimated Doppler value, e.g., as described below.

In other aspects, processor 1234 may be configured to provide the processed data 1205 to include any other suitable additional or alternative information, which may include, and/or may be based on, the one or more estimated RDAz-based Doppler folds 1233.

In some demonstrative aspects, processor 1234 may be configured to determine an estimated RDAz-based Doppler fold 1233, which may include, for example, an estimated residual Doppler fold value, which may result from a folding of an actual Doppler value according to a Doppler folding value, e.g., as described below.

In some demonstrative aspects, processor 1234 may be configured to determine the one or more estimated RDAz-based Doppler folds 1233 to include, for example, a plurality of estimated RDAz-based Doppler folds 1233, for example, corresponding to a respective plurality of RDAz bins, e.g., as described below.

In some demonstrative aspects, processor 1234 may be configured to identify one or more RDAz bins from a plurality of RDAz bins corresponding to an RD bin, and to determine the one or more estimated RDAz-based Doppler folds 1233, for example, for the one or more identified RDAz bins, e.g., as descried below.

In some demonstrative aspects, processor 1234 may be configured to identify the one or more RDAz bins, for example, based on a detection criterion, which may be applied to the first plurality of values and/or the second plurality of values, e.g., as described below.

In some demonstrative aspects, the detection criterion may include, for example, an azimuth-based detection criterion to detect potential targets, for example, along an azimuth axis, e.g., as described below.

In other aspects, processor 1234 may be configured to identify the one or more RDAz bins based on any other additional or alternative detection criterion applied to the first plurality of values, the second plurality of values, and/or any other parameter.

In some demonstrative aspects, processor 1234 may be configured to determine a measurement vector corresponding to an RDAz bin, for example, based on the first plurality of values corresponding to the first plurality of virtual antennas 1242 and the second plurality of values corresponding to the second plurality of virtual antennas 1244, e.g., as described below.

In some demonstrative aspects, processor 1234 may be configured to determine an estimated RDAz-based Doppler fold 1233 corresponding to the RDAz bin, for example, based on the measurement vector corresponding to the RDAz bin, e.g., as described below.

In some demonstrative aspects, processor 1234 may be configured to determine the estimated RDAz-based Doppler fold 1233 corresponding to the RDAz bin, for example, based on a matching between the measurement vector corresponding to the RDAz bin and a plurality of reference vectors corresponding to a respective plurality of Doppler fold values, e.g., as described below.

In some demonstrative aspects, the plurality of reference vectors may be based, for example, on a time difference between a second time and a first time, e.g., as described below.

In some demonstrative aspects, the first time may include a first transmission time of a first radar Tx signal from a first Tx antenna of the first plurality of Tx antennas 1214, e.g., as described below.

In some demonstrative aspects, the second time may include a second transmission time of a second radar Tx signal from a second Tx antenna of the second plurality of Tx antennas 1216, e.g., as described below.

In some demonstrative aspects, processor 1234 may be configured to identify a reference vector having a maximal match with the measurement vector corresponding to the RDAz bin, e.g., as described below.

In some demonstrative aspects, processor 1234 may be configured to determine the estimated RDAz-based Doppler fold 1233 corresponding to the RDAz bin, for example, based on a Doppler fold value corresponding to the identified reference vector, e.g., as described below.

In some demonstrative aspects, radar processor 1230 may include a memory 1238, for example, to store the plurality of reference vectors, e.g., as described below.

For example, processor 1234 may be configured to retrieve the plurality of reference vectors from the memory 1238, for example, based on the time difference and/or any other additional or alternative parameter.

For example, memory 838 (FIG. 8) may include one or more elements of memory 1238, and/or may perform one or more operations and/or functionalities of memory 1238.

In other aspects, memory 1238 may be implemented as part of any other, dedicated, or non-dedicated, element of a radar device, e.g., radar device 800 (FIG. 8) or radar device 910 (FIG. 9), and/or a radar system, e.g., radar system 901 (FIG. 9).

In other aspects, processor 1234 may be configured to determine the plurality of reference vectors, e.g., in real time, for example, based on the time difference and/or any other additional or alternative parameter.

In some demonstrative aspects, processor 1234 may be configured to determine a first plurality of azimuth-based values corresponding to the first plurality of virtual antennas 1242, for example, based on the first plurality of values corresponding to the first plurality of virtual antennas 1242, e.g., as described below.

In some demonstrative aspects, processor 1234 may be configured to determine a second plurality of azimuth-based values corresponding to the second plurality of virtual antennas 1244, for example, based on the second plurality of values corresponding to the second plurality of virtual antennas 1244, e.g., as described below.

In some demonstrative aspects, processor 1234 may be configured to determine the one or more estimated RDAz-based Doppler folds 1233, for example, based on the first plurality of azimuth-based values and the second plurality of azimuth-based values, e.g., as described below.

In other aspects, processor 1234 may be configured to determine the one or more estimated RDAz-based Doppler folds 1233 based on any other additional or alternative information.

In some demonstrative aspects, processor 1234 may be configured to determine the first plurality of azimuth-based values corresponding to the first plurality of virtual antennas 1242, for example, based on a first plurality of sets of FFT values corresponding to a first plurality of virtual antenna rows in the first plurality of virtual antennas 1242, e.g., as described below.

In some demonstrative aspects, processor 1234 may be configured to determine the second plurality of azimuth-based values corresponding to the second plurality of virtual antennas 1244, for example, based on a second plurality of sets of FFT values corresponding to a second plurality of virtual antenna rows in the second plurality of virtual antennas 1244, e.g., as described below.

In some demonstrative aspects, processor 1234 may be configured to determine the first plurality of azimuth-based values and/or the second plurality of azimuth-based values, for example, based on FFT techniques, e.g., as described below.

In other aspects, processor 1234 may be configured to determine the first plurality of azimuth-based values and/or the second plurality of azimuth-based values, for example, based on Super-Resolution (SR) techniques, and/or any other suitable processing technique.

In other aspects, processor 1234 may be configured to determine the first plurality of azimuth-based values corresponding to the first plurality of virtual antennas 1242, and/or the second plurality of azimuth-based values corresponding to the second plurality of virtual antennas 1244 based on any other additional or alternative information.

In some demonstrative aspects, processor 1234 may be configured to determine an estimated RDAz-based Doppler fold 1233 corresponding to an RDAz bin, which corresponds to an Azimuth (Az) bin, for example, based on a first subset of azimuth-based values in the first plurality of azimuth-based values and a second subset of azimuth-based values in the second plurality of azimuth-based values, e.g., as described below.

In some demonstrative aspects, the first subset of azimuth-based values and/or the second subset of azimuth-based values may correspond to the Az bin, e.g., as described below.

In some demonstrative aspects, processor 1234 may be configured to determine the measurement vector corresponding to the RDAz bin, for example, based on the first subset of azimuth-based values and/or the second subset of azimuth-based values, e.g., as described below.

In some demonstrative aspects, the first subset of azimuth-based values may correspond to a first subset of virtual antennas 1243 in the first plurality of virtual antennas 1242, e.g., as described below.

In some demonstrative aspects, the first subset of virtual antennas 1243 may include, for example, a first column of virtual antennas in the virtual antenna array 1240, e.g., as described below.

In some demonstrative aspects, the second subset of azimuth-based values may correspond to a second subset of virtual antennas 1245 in the second plurality of virtual antennas 1244, e.g., as described below.

In some demonstrative aspects, the second subset of virtual antennas 1245 may include, for example, a second column of virtual antennas in the virtual antenna array 1240, e.g., as described below.

In some demonstrative aspects, processor 1234 may be configured to determine the estimated RDAz-based Doppler fold 1233 corresponding to the RDAz bin, for example, based on the measurement vector corresponding to the RDAz bin, e.g., as described below.

In some demonstrative aspects, processor 1234 may be configured to determine the measurement vector corresponding to the RDAz bin, for example, based on a first vector and a second vector, e.g., as described below.

In some demonstrative aspects, processor 1234 may be configured to determine the measurement vector corresponding to the RDAz bin, for example, based on a product of the first vector and the second vector, e.g., as described below.

In some demonstrative aspects, processor 1234 may be configured to determine the measurement vector corresponding to the RDAz bin, for example, based on a Hadamard product of the first vector and the second vector, e.g., as described below.

In other aspects, processor 1234 may be configured to determine the measurement vector corresponding to the RDAz bin, for example, based on any other additional and/or alternative calculation, method, and/or technique.

In some demonstrative aspects, the first vector may be based, for example, on the first subset of azimuth-based values, e.g., as described below.

In some demonstrative aspects, the first vector may include a conjugate of the first subset of azimuth-based values, e.g., as described below.

In some demonstrative aspects, the second vector may be based, for example, on the second subset of azimuth-based values, e.g., as described below.

In some demonstrative aspects, the second vector may include the second subset of azimuth-based values, e.g., as described below.

In some demonstrative aspects, radar processor 1230 may include a controller 1232, which may be configured to control transmission of the radar Tx signals 1203, e.g., as described below. For example, radar processor 834 (FIG. 8) may include one or more elements of controller 1232, and/or may perform one or more operations and/or functionalities of controller 1232; and/or BB processor 930 (FIG. 9) may include one or more elements of controller 1232, and/or may perform one or more operations and/or functionalities of controller 1232.

In some demonstrative aspects, controller 1232 may include, or may be implemented, partially or entirely, by circuitry and/or logic, e.g., one or more processors including circuitry and/or logic, memory circuitry and/or logic. Additionally or alternatively, one or more functionalities of controller 1232 may be implemented by logic, which may be executed by a machine and/or one or more processors, e.g., as described below.

In other aspects, controller 1232 may be implemented as part of any other, dedicated, or non-dedicated, element of a radar device, e.g., radar device 800 (FIG. 8) or radar device 910 (FIG. 9), and/or a radar system, e.g., radar system 901 (FIG. 9).

In some demonstrative aspects, controller 1232 may be configured to control transmission of the radar Tx signals 1203, for example, in a sequence of Tx row transmissions via Tx rows of the Tx array 1211, e.g., as described below.

In some demonstrative aspects, an order of transmissions in the sequence of Tx row transmissions may be different from an order of the Tx rows, e.g., as described below.

In some demonstrative aspects, the order of transmissions in the sequence of Tx 33 may be substantially random, e.g., as described below.

In some demonstrative aspects, the order of transmissions in the sequence of Tx row transmissions may preconfigured and/or predefined, e.g., according to a predefined Tx coding scheme.

In some demonstrative aspects, the order of transmissions in the sequence of Tx row transmissions may be according to an order of the Tx rows, e.g., as described below.

In other aspects, controller 1232 may be configured to control transmission of the radar Tx signals 1203 according to any other additional or alternative suitable order, arrangement and/or configuration.

In some demonstrative aspects, system 1200 may include a radar processor 1260, which may be configured to generate radar information 1267, for example, based on the processed data 1205, e.g., as described below.

For example, radar processor 834 (FIG. 8) may include one or more elements of radar processor 1260, and/or may perform one or more operations and/or functionalities of radar processor 1260; and/or BB processor 930 (FIG. 9) may include one or more elements of radar processor 1260, and/or may perform one or more operations and/or functionalities of radar processor 1260.

In some demonstrative aspects, radar processor 1260 may include, or may be implemented, partially or entirely, by circuitry and/or logic, e.g., one or more processors including circuitry and/or logic, memory circuitry and/or logic. Additionally or alternatively, one or more functionalities of radar processor 1260 may be implemented by logic, which may be executed by a machine and/or one or more processors, e.g., as described below.

In other aspects, radar processor 1260 may be implemented as part of any other, dedicated, or non-dedicated, element of a radar device, e.g., radar device 800 (FIG. 8) or radar device 910 (FIG. 9), and/or a radar system, e.g., radar system 901 (FIG. 9).

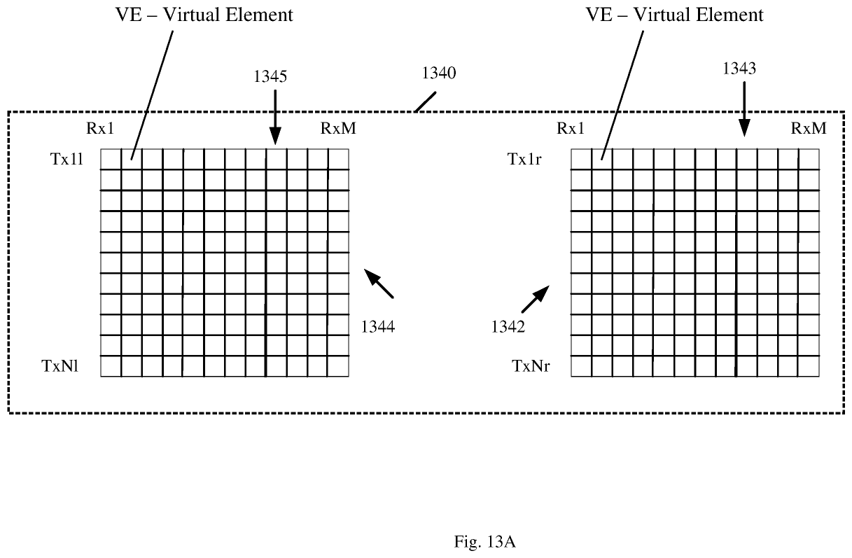

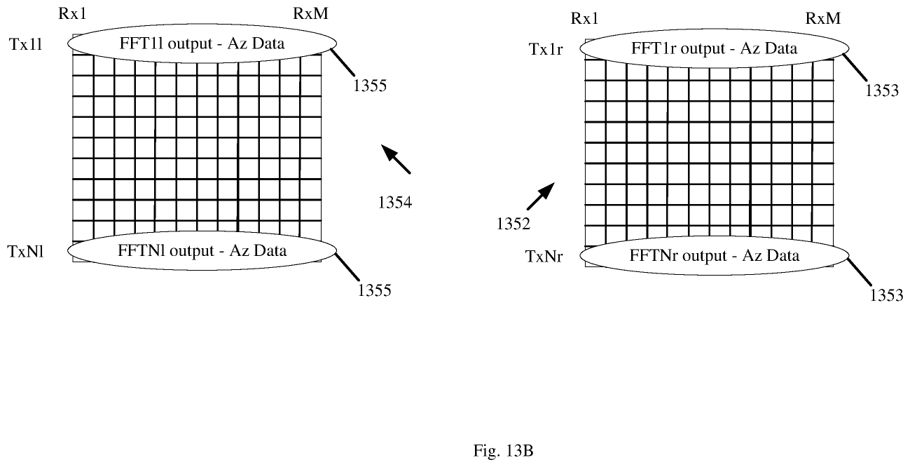

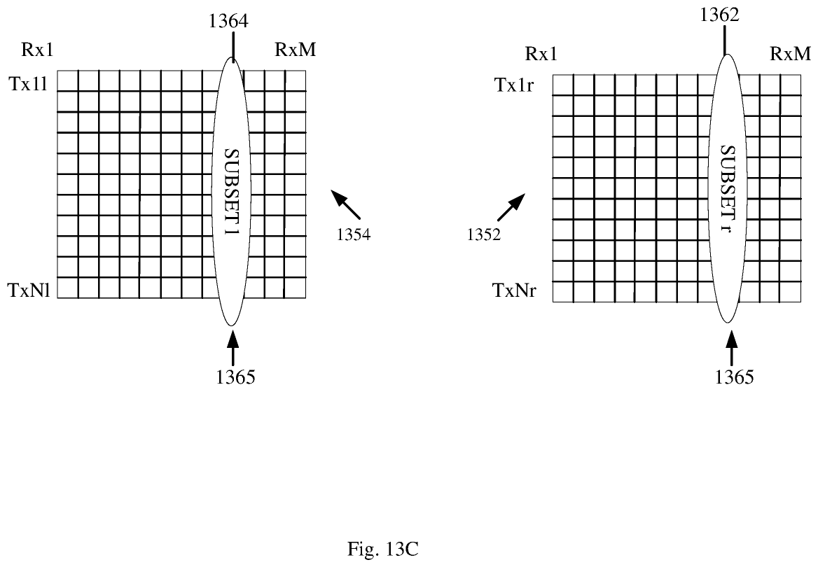

Reference is made to FIGS. 13A, 13B, and 13C, which conceptually illustrate operations according to a radar processing technique to generate Doppler fold information, in accordance with some demonstrative aspects. For example, processor 1234 (FIG. 12) may be configured to perform one or more operations of the radar processing technique of FIGS. 13A, 13B, and/or 13C, for example, to determine the Doppler fold information.

In some demonstrative aspects, as shown in FIG. 13A, the radar processing technique may include processing RD information corresponding to an RD bin to identify a first plurality of values corresponding to a first plurality of virtual antennas 1342 of a virtual antenna array 1340, e.g., as described below. For example, the virtual antenna array 1340 may include virtual antenna array 1240 (FIG. 12).

In some demonstrative aspects, as shown in FIG. 13A, the radar processing technique may include processing the RD information corresponding to the RD bin to identify a second plurality of values corresponding to a second plurality of virtual antennas 1344 of the virtual antenna array 1340, e.g., as described below.

In some demonstrative aspects, the virtual antenna array 1340 may be based on an antenna array including a Tx array and an Rx array. For example, the virtual antenna array 1340 may be based on the Tx array 1211 (FIG. 11) and the Rx array 1221 (FIG. 12) of antenna array 1210 (FIG. 12).

In some demonstrative aspects, the Tx array may include a first column, e.g., a right (r) column, of Tx antennas including a first plurality of Tx antennas, denoted Tx1r-TxNr. For example, the right column of Tx antennas may include Tx antennas 1214 (FIG. 12).

In some demonstrative aspects, the Tx array may include a second column, e.g., a left (l) column, of Tx antennas including a second plurality of Tx antennas, denoted Tx1l-TxNl. For example, the left column of Tx antennas may include Tx antennas 1216 (FIG. 12).

In some demonstrative aspects, the Rx array may include a row of Rx antennas, denoted Rx1-RxM. For example, the row of Rx antennas may include Rx antennas 1222 (FIG. 12).

In some demonstrative aspects, as shown in FIG. 13A, the first plurality of virtual antennas 1342 may be based, for example, on combinations between the plurality of Rx antennas Rx1-RxM and the first plurality of Tx antennas Tx1r-TxNr.

In some demonstrative aspects, as shown in FIG. 13A, the second plurality of virtual antennas 1344 may be based, for example, on combinations between the plurality of Rx antennas Rx1-RxM and the second plurality of Tx antennas Tx1l-TxNl.

For example, as shown in FIG. 13A, the virtual antenna 1340 may include N antenna rows, e.g., corresponding to the TxNr antennas and the TxNl antennas.

In some demonstrative aspects, as shown in FIG. 13B, the radar processing technique may include determining a first plurality of azimuth-based values 1352 corresponding to the first plurality of virtual antennas 1242, for example, based on the first plurality of values corresponding to the first plurality of virtual antennas 1342.

In some demonstrative aspects, as shown in FIG. 13B, the radar processing technique may include determining a second plurality of azimuth-based values 1354 corresponding to the second plurality of virtual antennas 1344, for example, based on the second plurality of values corresponding to the second plurality of virtual antennas 1344.

In some demonstrative aspects, as shown in FIG. 13B, a processor, e.g., processor 1234 (FIG. 12), may be configured to determine the first plurality of azimuth-based values 1352, for example, based on a first plurality of sets of FFT values 1353, denoted FFT1r-FFTNr, which may correspond, for example, to a first plurality of virtual antenna rows in the first plurality of virtual antennas 1342.

For example, a set of FFT values 1353 corresponding to a virtual antenna row of the first plurality of virtual antennas 1342 may be based, for example, on an FFT applied to a set of values corresponding to a respective set of virtual antennas in the antenna row.

In some demonstrative aspects, as shown in FIG. 13B, the processor, e.g., processor 1234 (FIG. 12), may be configured to determine the second plurality of azimuth-based values 1354, for example, based on a second plurality of sets of FFT values 1355, denoted FFT1l-FFTNl, which may correspond, for example, to a second plurality of virtual antenna rows in the second plurality of virtual antennas 1344, e.g., as described below.

For example, a set of FFT values 1353 corresponding to a virtual antenna row of the second plurality of virtual antennas 1344 may be based, for example, on an FFT applied to a set of values corresponding to a respective set of virtual antennas in the antenna row.

In some demonstrative aspects, as shown in FIG. 13C, the radar processing technique may include determining an estimated RDAz-based Doppler fold, denoted vs. corresponding to an RDAz bin 1365, which corresponds to an Azimuth (Az) bin, e.g., as described below.

In some demonstrative aspects, as shown in FIG. 13C, the processor, e.g., processor 1234 (FIG. 12), may be configured to determine the estimated RDAz-based Doppler fold vr, for example, based on a first subset of azimuth-based values 1362 in the first plurality of azimuth-based values 1352, and a second subset of azimuth-based values 1364 in the second plurality of azimuth-based values 1354, e.g., as described below.

In some demonstrative aspects, as shown in FIG. 13C, the first subset of azimuth-based values 1362 and the second subset of azimuth-based values 1364 may correspond to the Az bin.

In some demonstrative aspects, as shown in FIG. 13C and FIG. 13A, the first subset of azimuth-based values 1362 (FIG. 13C) may correspond to a first subset of virtual antennas 1343 (FIG. 13A) in the first plurality of virtual antennas 1342 (FIG. 13A).

In some demonstrative aspects, as shown in FIG. 13A, the first subset of virtual antennas 1343 may include a first column of virtual antennas in the virtual antenna array 1340.

In some demonstrative aspects, as shown in FIG. 13C and FIG. 13A, the second subset of azimuth-based values 1364 (FIG. 13C) may correspond to a second subset of virtual antennas 1345 (FIG. 13A) in the second plurality of virtual antennas 1344 (FIG. 13A).

In some demonstrative aspects, as shown in FIG. 13A, the second subset of virtual antennas 1345 may include a second column of virtual antennas in the virtual antenna array 1340.

In some demonstrative aspects, the processor, e.g., processor 1234 (FIG. 12), may be configured to determine a measurement vector, denoted Zmeas, corresponding to the RDAz bin 1365, for example, based on the first subset of azimuth-based values 1362 and the second subset of azimuth-based values 1364.

In some demonstrative aspects, the processor, e.g., processor 1234 (FIG. 12), may be configured to determine the estimated RDAz-based Doppler fold vs. corresponding to the RDAz bin 1365, for example, based on the measurement vector Zmeas corresponding to the RDAz bin 1365.

In some demonstrative aspects, the processor, e.g., processor 1234 (FIG. 12), may be configured to determine the measurement vector Zmeas corresponding to the RDAz bin, for example, based on a first vector and a second vector, e.g., as described below.

In some demonstrative aspects, the first vector may be based, for example, on the first subset of azimuth-based values 1362, e.g., as described below.

In some demonstrative aspects, the first vector may include, for example, a vector, denoted yᵣ, including the first subset of azimuth-based values, e.g., as described below.

In some demonstrative aspects, the second vector may be based, for example, on the second subset of azimuth-based values 1364, e.g., as described below.

In some demonstrative aspects, the second vector may include a conjugate of a vector, denoted yₗ, including the second subset of azimuth-based values 1364, e.g., as described below.

In some demonstrative aspects, the processor, e.g., processor 1234 (FIG. 12), may be configured to determine the measurement vector Zmeas corresponding to the RDAz bin, for example, based on a Hadamard product of the first vector and the second vector, e.g., as described below.

In other aspects, the measurement vector Zmeas corresponding to the RDAz bin may be determined based on any other additional or alternative parameters, vectors and/or calculations.

In some demonstrative aspects, the processor, e.g., processor 1234 (FIG. 12), may be configured to determine the estimated RDAz-based Doppler fold vs. corresponding to the RDAz bin 1365, for example, based on a matching (also referred to as a “phase template match”) between the measurement vector Zmeas corresponding to the RDAz bin 1365 and a plurality of reference vectors corresponding to a respective plurality of Doppler fold values, e.g., as described below.

In some demonstrative aspects, the processor, e.g., processor 1234 (FIG. 12), may be configured to identify a reference vector, denoted Zmodel, having a maximal match with the measurement vector Zmeas corresponding to the RDAz bin 1365.

In some demonstrative aspects, the processor, e.g., processor 1234 (FIG. 12), may be configured to determine the estimated RDAz-based Doppler fold vs. corresponding to the RDAz bin 1365, for example, based on a Doppler fold value corresponding to the reference vector Zmodel, e.g., as described below.

For example, the estimated RDAz-based Doppler fold vs. corresponding to the RDAz bin 1365 may include the Doppler fold value corresponding to the reference vector Zmodel, which may have, for example, the maximal match with the measurement vector Zmeas, e.g., as described below.

In some demonstrative aspects, a Doppler ambiguity may introduce a phase shift over different transmit waveforms, for example, in case a duration of transmit time slots is shorter than a pulse repetition interval (PRI).

In some demonstrative aspects, the measurement vector Zmeas may be implemented, for example, to represent a measured phase shift, which may be matched, for example, to a plurality of reference vectors Zmodel representing a plurality of expected phase shift templates, e.g., corresponding to a respective plurality of different Doppler folds.

In some demonstrative aspects, the estimated RDAz-based Doppler fold vs may be determined, for example, based on identified reference vectors Zmodel, which may be determined to have, for example, a best match with the measurement vector Zmeas.

In some demonstrative aspects, the phase template match may be performed, for example, per range bin, per Doppler bin, and/or per azimuth bin, e.g., per an RDAz bin.

In some demonstrative aspects, for example, assuming transmit time slots t∈R^{N}^{ₜₓ} in [seconds], a vector, denoted y, may be determined, for example, after RD processing and azimuth processing, e.g., processing of columns in virtual array 1340, and folded Doppler phase compensation, e.g., due to different transmit times. For example, the vector y, may include values corresponding to the right part, e.g., the first plurality of virtual antennas 1342, and the left part, e.g., the second plurality of virtual antennas 1362, of the of virtual antenna 1340, e.g., as follows:

$$\\ y = {e}^{{}_{} {jtv}_{F}} ⊙ [ {\sum }_{i = 1}^{K} {a}_{i} {e}^{{}_{} {jw}_{i} n} , {e}^{{}_{} i ϕ} {\sum }_{i = 1}^{K} {a}_{i} {e}^{{}_{} {jw}_{i} n} ] + w ∈ {R}^{{}_{} {N}_{tx}}$$

wherein:
K denotes a number of reflectors for a given RDAz bin.
t denotes a transmission time from a Tx array.
v_{F}=v−modelus (v, v_{fold}), wherein modelus (v, v_{fold}) denotes a residual velocity fold value of a target, and v denotes an actual Doppler value, which may be folded, for example, according to a Doppler folding value, denoted v_{fold}.
ϕ denotes an unknown phase shift between a right virtual subarray, e.g., including the first plurality of virtual antennas 1342, and a left virtual subarray e.g., including the second plurality of virtual antennas 1344, for example, due to multipath and/or an azimuth angle phase residual.
w denotes a complex normal noise vector.
wᵢ denotes an elevation frequency of an i-th target, e.g.,

$$\\ {w}_{i} = \frac{2 π sin ( {θ}_{el} )}{λ} .$$

n denotes a height displacement of a transmission antenna, e.g., in meters.
⊙ denotes a Hadamard product, e.g., an element-wise product.

In some demonstrative aspects, the vector y may be split into a first vector, denoted yᵣ, and the second vector, denoted yₗ, for example, y=[yₗ, yᵣ].

In some demonstrative aspects, the vector yᵣ may be based on a first transmission of a first radar Tx signal from a first Tx antenna of the first plurality of Tx antennas Tx1r-TxNr.

In some demonstrative aspects, the first transmission of the first radar Tx signal may be at a first time slot, denoted tᵣ.

In some demonstrative aspects, the vector yₗ may be based on a second transmission of a second radar Tx signal from a second Tx antenna of the second plurality of Tx antennas Tx1l-TxNl.

In some demonstrative aspects, the second transmission of the second radar Tx signal may be at a second time slot, denoted ty, e.g., tᵣ, e.g., t=[tₗ, tᵣ]

In some demonstrative aspects, the first vector yᵣ and the second vector yₗ, may be determined, e.g., as follows:

$$\\ {y}_{l} = {e}^{{}_{} {jt}_{l} {v}_{F}} ⊙ {\sum }_{i = 1}^{K} {a}_{i} {e}^{{}_{} {jw}_{i} n} + w = s + w$$

$$\\ {y}_{r} = {e}^{{}_{} {jt}_{r} {v}_{F}} ⊙ {e}^{{}_{} i ϕ} ⊙ {\sum }_{i = 1}^{K} {a}_{i} {e}^{{}_{} {jw}_{i} n} + w = {e}^{{}_{} j Δ {tv}_{F}} ⊙ s + w$$

wherein:
Δt denotes a Tx time delay between the first transmission time tᵣ and the second transmission time tₗ, e.g., from Tx antennas in a same row, e.g., Δt=tᵣ−tₗ.

$$\\ s = {e}^{{}_{} {jt}_{l} {v}_{F}} {\sum }_{i = 1}^{K} {a}_{i} {e}^{{}_{} {jw}_{i} n} .$$

In some demonstrative aspects, the measurement vector zₘₑₐₛ may be estimated, for example, based on a Hadamard product of the vector yᵣ with a conjugate of the vector yₗ, e.g., as follows:

$$\\ {z}_{meas} = conj ( {y}_{l} ) ⊙ {y}_{r}$$

In some demonstrative aspects, a plurality of reference vectors z_{model} corresponding to a respective plurality of different Doppler folds v_{F} may be determined, e.g., as follows:

$$\\ {z}_{model} = {e}^{{}_{} j ϕ} ( s ⊙ conj ( s ) ) ⊙ {e}^{{}_{} j Δ {tv}_{F}} + 2 Re \{ s * w \}$$

In some demonstrative aspects, a processor, e.g., processor 1234 (FIG. 12), may be configured to determine the estimated RDAz-based Doppler fold vs corresponding to the RDAz bin, for example, based on a matching between the reference vector z_{model} and the measurement vectors zₘₑₐₛ, e.g., as follows:

zₘₑₐₛ˜z_{model}

In some demonstrative aspects, it may be assumed that:

$$\\ ( s ⊙ conj ( s ) ) \sim A \cdot ones ( \frac{{N}_{tx}}{2} , 1 ) ,$$

which may be valid, e.g., for a single elevation target per RDAz bin. For example, this assumption may imply that:

2Re{s*w}˜N(0,4A²σ_{w}²)

In some demonstrative aspects, the plurality of reference vectors z_{model} may be rewritten, for example, based on this assumption, e.g., as follows:

$$\\ {z}_{model} = {e}^{{}_{} j ϕ} A ones ( {num}_{TX} / 2 ) ⊙ {e}^{{}_{} j Δ {tv}_{F}}$$

In some demonstrative aspects, the measurement vector zₘₑₐₛ may be matched to a plurality of expected phasors e^{jtv}^{_{F}} representing the plurality of reference vectors z_{model}.

In some demonstrative aspects, the estimated RDAz-based Doppler fold vs corresponding to the RDAz may be determined, for example, by a phase invariant match filtering between the measurement vector zₘₑₐₛ and the plurality of expected phasors e^{jtv}^{_{F}}, e.g., as follows:

$$\\ {\hat{v}}_{F} = arg {max}_{{V}_{F}} \vert < {z}_{meas} , {e}^{{}_{} j Δ {tv}_{F}} > \vert$$

For example, the estimated RDAz-based Doppler fold vs corresponding to the RDAz may be determined to include a Doppler fold resulting in a maximal match between the zₘₑₐₛ and the expected phasor e^{jtv}^{_{F}} corresponding to the Doppler fold.

In some demonstrative aspects, this algorithm may be suitable, for example, for applying to an RDAz bin, e.g., to each RDAz bin, for example, to extract a unique Doppler fold v_{F} for the RDAz bin.

In some demonstrative aspects, for example, under constraints of all possible transmit times, a codebook e^{jtv}^{_{F}} may be transmitted, for example, by designing a transmit time vector t, which may minimize wrong Doppler fold detection. For example, controller 1232 (FIG. 12) may be configured to control transmissions via the Tx antenna array 1211 (FIG. 11), for example, according to the transmit time vector t.

In some demonstrative aspects, controller 1232 (FIG. 12) may be configured to control transmissions via the Tx antenna array 1211 (FIG. 11), for example, such that a distance between the plurality of reference vectors, e.g., between the symbols {e^{jtv}^{_{F}}}ᵥ_{_{F}}_{=-N}_{_{f}}_{, . . . , N}_{_{f}}, may be maximized, for example, to minimize a symbol/fold classification error.

In some demonstrative aspects, the radar processing mechanism described above may be implemented to support a technical solution to design a sparse virtual array, e.g., virtual array 1170 (FIG. 11), for example, even without degrading a Doppler fold estimation, for example, since the measurement vector zₘₑₐₛ may be independent of the transmission antenna displacement in height n.

In some demonstrative aspects, the sparse virtual array, e.g., virtual array 1170 (FIG. 11), may be configured as a uniform virtual array. In other aspects, the sparse virtual array, e.g., virtual array 1170 (FIG. 11), may be configured as a non-uniform virtual array.

In some demonstrative aspects, the radar processing mechanism described above may be implemented to provide a technical solution to support a sparse RD scheme. In one example, the sparse RD scheme may be utilized by a radar device, which may implement a step-frequency radar waveform.

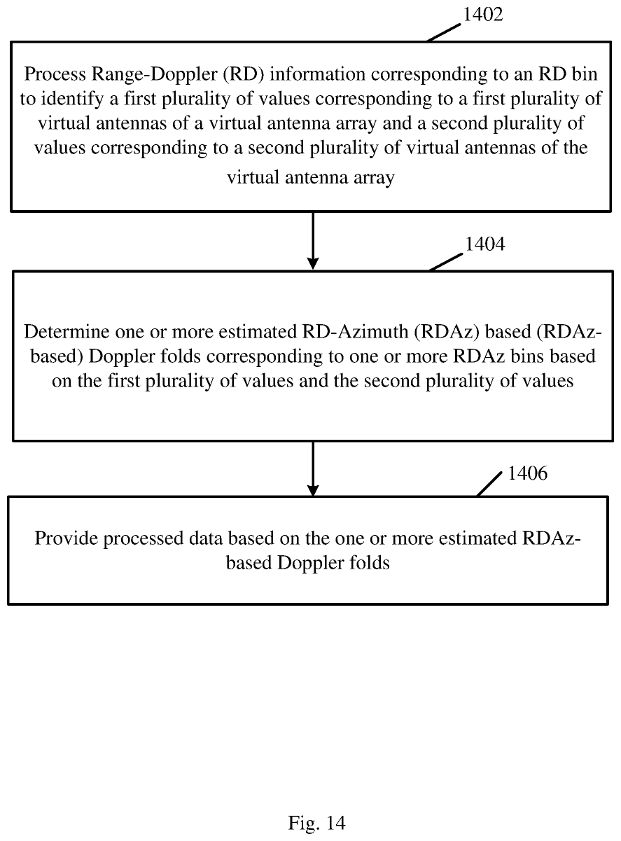

Reference is made to FIG. 14, which schematically illustrates a method of processing RD information, in accordance with some demonstrative aspects. For example, one or more of the operations of the method of FIG. 14 may be performed by a system, e.g., radar system 900 (FIG. 9), and/or system 1200 (FIG. 13), a radar device, e.g., radar device 101 (FIG. 1), radar device 800 (FIG. 8), and/or radar device 910 (FIG. 9); a processor, e.g., radar processor 1230 (FIG. 12), processor 1234 (FIG. 12), controller 1232 (FIG. 12), radar processor 834 (FIG. 8), and/or baseband processor 930 (FIG. 9).

As indicated at block 1402, the method may include processing RD information corresponding to an RD bin to identify a first plurality of values corresponding to a first plurality of virtual antennas of a virtual antenna array and a second plurality of values corresponding to a second plurality of virtual antennas of the virtual antenna array. For example, the RD information corresponding to the RD bin may be based on radar Rx signals received by a plurality of Rx antennas based on radar Tx signals from a Tx array including a first plurality of Tx antennas and a second plurality of Tx antennas. For example, the first plurality of virtual antennas may be based on the plurality of Rx antennas and the first plurality of Tx antennas, and the second plurality of virtual antennas may be based on the plurality of Rx antennas and the second plurality of Tx antennas. For example, processor 1234 (FIG. 12) may be configured to process the RD information 1235 (FIG. 12) corresponding to the RD bin to identify the first plurality of values corresponding to the first plurality of virtual antennas 1242 (FIG. 12) of the virtual antenna array 1240 (FIG. 12) and the second plurality of values corresponding to the second plurality of virtual antennas 1244 (FIG. 12) of the virtual antenna array 1240 (FIG. 12), e.g., as described above.

As indicated at block 1404, the method may include determining one or more estimated RDAz-based Doppler folds corresponding to one or more RDAz bins based, for example, on the first plurality of values and the second plurality of values. For example, processor 1234 (FIG. 12) may be configured to determine the one or more estimated RDAz-based Doppler folds 1233 (FIG. 12) corresponding to the one or more RDAz bins, for example, based on the first plurality of values and the second plurality of values, e.g., as described above.

As indicated at block 1406, the method may include providing processed data based on the one or more estimated RDAz-based Doppler folds. For example, processor 1234 (FIG. 12) may be configured to provide the processed data 1205 (FIG. 12), e.g., via output 1236 (FIG. 12), for example, based on the one or more estimated RDAz-based Doppler folds 1233 (FIG. 12), e.g., as described above.

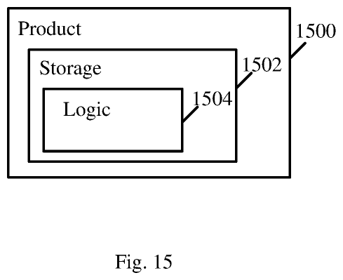

Reference is made to FIG. 15, which schematically illustrates a product of manufacture 1500, in accordance with some demonstrative aspects. Product 1500 may include one or more tangible computer-readable (“machine-readable”) non-transitory storage media 1502, which may include computer-executable instructions, e.g., implemented by logic 1504, operable to, when executed by at least one computer processor, enable the at least one computer processor to implement one or more operations and/or functionalities described with reference to any of the FIGS. 1-14, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 1500 and/or machine-readable storage media 1502 may include one or more types of computer-readable storage media capable of storing data, including volatile memory, non-volatile memory, removable or non-removable memory, erasable or non-erasable memory, writeable or re-writeable memory, and the like. For example, machine-readable storage media 1502 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a disk, a hard drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 1504 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 1504 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### EXAMPLES

The following examples pertain to further aspects.

Example 1 includes an apparatus comprising a processor configured to process Range-Doppler (RD) information corresponding to an RD bin to identify a first plurality of values corresponding to a first plurality of virtual antennas of a virtual antenna array and a second plurality of values corresponding to a second plurality of virtual antennas of the virtual antenna array, wherein the RD information corresponding to the RD bin is based on radar Receive (Rx) signals received by a plurality of Rx antennas based on radar Transmit (Tx) signals from a Tx array including a first plurality of Tx antennas and a second plurality of Tx antennas, wherein the first plurality of virtual antennas is based on the plurality of Rx antennas and the first plurality of Tx antennas, the second plurality of virtual antennas is based on the plurality of Rx antennas and the second plurality of Tx antennas; and determine one or more estimated RD-Azimuth (RDAz) based (RDAz-based) Doppler folds corresponding to one or more RDAz bins based on the first plurality of values and the second plurality of values; and an output to provide processed data based on the one or more estimated RDAz-based Doppler folds.

Example 2 includes the subject matter of Example 1, and optionally, wherein the processor is configured to determine a measurement vector corresponding to an RDAz bin based on the first plurality of values and the second plurality of values, and to determine an estimated RDAz-based Doppler fold corresponding to the RDAz bin based on the measurement vector corresponding to the RDAz bin.

Example 3 includes the subject matter of Example 2, and optionally, wherein the processor is configured to determine the estimated RDAz-based Doppler fold corresponding to the RDAz bin based on a matching between the measurement vector corresponding to the RDAz bin and a plurality of reference vectors corresponding to a respective plurality of Doppler fold values.

Example 4 includes the subject matter of Example 3, and optionally, wherein the processor is configured to identify a reference vector having a maximal match with the measurement vector corresponding to the RDAz bin, and to determine the estimated RDAz-based Doppler fold corresponding to the RDAz bin based on a Doppler fold value corresponding to the reference vector.

Example 5 includes the subject matter of Example 3 or 4, and optionally, wherein the plurality of reference vectors are based on a time difference between a second time and a first time, wherein the first time comprises a first transmission time of a first radar Tx signal from a first Tx antenna of the first plurality of Tx antennas, the second time comprising a second transmission time of a second radar Tx signal from a second Tx antenna of the second plurality of Tx antennas.

Example 6 includes the subject matter of any one of Examples 3-5, and optionally, comprising a memory to store the plurality of reference vectors.

Example 7 includes the subject matter of any one of Examples 1-6, and optionally, wherein the processor is configured to determine a first plurality of azimuth-based values corresponding to the first plurality of virtual antennas based on the first plurality of values, to determine a second plurality of azimuth-based values corresponding to the second plurality of virtual antennas based on the second plurality of values, and to determine the one or more estimated RDAz-based Doppler folds based on the first plurality of azimuth-based values and the second plurality of azimuth-based values.

Example 8 includes the subject matter of Example 7, and optionally, wherein the processor is configured to determine an estimated RDAz-based Doppler fold corresponding to an RDAz bin, which corresponds to an Azimuth (Az) bin, based on a first subset of azimuth-based values in the first plurality of azimuth-based values and a second subset of azimuth-based values in the second plurality of azimuth-based values, wherein the first subset of azimuth-based values and the second subset of azimuth-based values correspond to the Az bin.

Example 9 includes the subject matter of Example 8, and optionally, wherein the processor is configured to determine a measurement vector corresponding to the RDAz bin based on the first subset of azimuth-based values and the second subset of azimuth-based values, and to determine the estimated RDAz-based Doppler fold corresponding to the RDAz bin based on the measurement vector corresponding to the RDAz bin.

Example 10 includes the subject matter of Example 9, and optionally, wherein the processor is configured to determine the measurement vector corresponding to the RDAz bin based on a Hadamard product of a first vector and a second vector, the first vector is based on the first subset of azimuth-based values, the second vector is based on the second subset of azimuth-based values.

Example 11 includes the subject matter of claim 10, and optionally, wherein the first vector comprises a conjugate of the first subset of azimuth-based values, the second vector comprises the second subset of azimuth-based values.

Example 12 includes the subject matter of any one of Examples 8-11, and optionally, wherein the first subset of azimuth-based values corresponds to a first subset of virtual antennas in the first plurality of virtual antennas, wherein the second subset of azimuth-based values corresponds to a second subset of virtual antennas in the second plurality of virtual antennas.

Example 13 includes the subject matter of Example 12, and optionally, wherein the first subset of virtual antennas comprises a first column of virtual antennas in the virtual antenna array, and the second subset of virtual antennas comprises a second column of virtual antennas in the virtual antenna array.

Example 14 includes the subject matter of any one of Examples 7-13, and optionally, wherein the processor is configured to determine the first plurality of azimuth-based values based on a first plurality of sets of Fast-Fourier-Transform (FFT) values corresponding to a first plurality of virtual antenna rows in the first plurality of virtual antennas, and to determine the second plurality of azimuth-based values based on a second plurality of sets of FFT values corresponding to a second plurality of virtual antenna rows in the second plurality of virtual antennas.

Example 15 includes the subject matter of any one of Examples 1-14, and optionally, wherein the one or more estimated RDAz-based Doppler folds comprises a first estimated RDAz-based Doppler fold corresponding to a first RDAz bin, and a second estimated RDAz-based Doppler fold corresponding to a second RDAz bin.

Example 16 includes the subject matter of Example 15, and optionally, wherein the first estimated RDAz-based Doppler fold is different from the second estimated RDAz-based Doppler fold.

Example 17 includes the subject matter of Example 15, and optionally, wherein the first estimated RDAz-based Doppler fold is equal to the second estimated RDAz-based Doppler fold.

Example 18 includes the subject matter of any one of Examples 1-17, and optionally, wherein the processed data comprises Doppler fold information to indicate the one or more estimated RDAz-based Doppler folds.

Example 19 includes the subject matter of Example 18, and optionally, wherein the processed data comprises processed radar data corresponding to the one or more RDAz bins, and the Doppler fold information comprising the one or more estimated RDAz-based Doppler folds.

Example 20 includes the subject matter of any one of Examples 1-19, and optionally, wherein the processor is configured to determine an estimated Doppler value for a target in an RDAz bin based on a sum of a Doppler value corresponding to the RD bin and an estimated RDAz-based Doppler fold corresponding to the RDAz bin, wherein the processed data is based on the estimated Doppler value.

Example 21 includes the subject matter of any one of Examples 1-20, and optionally, wherein an estimated RDAz-based Doppler fold comprises an estimated residual Doppler fold value resulting from a folding of an actual Doppler value according to a Doppler folding value.

Example 22 includes the subject matter of any one of Examples 1-21, and optionally, wherein the processor is configured to identify the one or more RDAz bins based on a detection criterion applied to the first plurality of values and the second plurality of values.

Example 23 includes the subject matter of Example 22, and optionally, wherein the detection criterion comprises an azimuth-based detection criterion to detect potential targets along an azimuth axis.

Example 24 includes the subject matter of any one of Examples 1-23, and optionally, wherein the first plurality of Tx antennas comprises a first column of Tx antennas, the second plurality of Tx antennas comprises a second column of Tx antennas, and the plurality of Rx antennas comprises a row of Rx antennas.

Example 25 includes the subject matter of Example 24, and optionally, comprising a controller configured to control transmission of the radar Tx signals in a sequence of Tx row transmissions via Tx rows of the Tx array.

Example 26 includes the subject matter of Example 25, and optionally, wherein an order of transmissions in the sequence of Tx row transmissions is different from an order of the Tx rows.

Example 27 includes the subject matter of Example 26, and optionally, wherein an order of transmissions in the sequence of Tx row transmissions is substantially random.

Example 28 includes the subject matter of any one of Examples 1-27, and optionally, comprising the plurality of Rx antennas, and the Tx array.

Example 29 includes the subject matter of any one of Examples 1-28, and optionally, comprising a radar processor configured to generate radar information based on the processed data.

Example 30 includes the subject matter of Example 29, and optionally, comprising a vehicle, the vehicle comprising a system controller to control one or more systems of the vehicle based on the radar information.

Example 31 includes a radar system comprising the subject matter of any of Examples 1-30.

Example 32 includes a vehicle comprising the subject matter of any of Examples 1-30.

Example 33 includes an apparatus comprising means for performing any of the described operations of any of Examples 1-30.

Example 34 includes a machine-readable medium that stores instructions for execution by a processor to perform any of the described operations of any of Examples 1-30.

Example 35 comprises a product comprising one or more tangible computer-readable non-transitory storage media comprising instructions operable to, when executed by at least one processor, enable the at least one processor to cause a device and/or system to perform any of the described operations of any of Examples 1-30.

Example 36 includes an apparatus comprising a memory; and processing circuitry configured to perform any of the described operations of any of Examples 1-30.

Example 37 includes a method including any of the described operations of any of Examples 1-30.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus comprising:
a processor configured to:
process Range-Doppler (RD) information corresponding to an RD bin to identify a first plurality of values corresponding to a first plurality of virtual antennas of a virtual antenna array and a second plurality of values corresponding to a second plurality of virtual antennas of the virtual antenna array, wherein the RD information corresponding to the RD bin is based on radar Receive (Rx) signals received by a plurality of Rx antennas based on radar Transmit (Tx) signals from a Tx array including a first plurality of Tx antennas and a second plurality of Tx antennas, wherein the first plurality of virtual antennas is based on the plurality of Rx antennas and the first plurality of Tx antennas, the second plurality of virtual antennas is based on the plurality of Rx antennas and the second plurality of Tx antennas; and
determine one or more estimated RD-Azimuth (RDAz) based (RDAz-based) Doppler folds corresponding to one or more RDAz bins based on the first plurality of values and the second plurality of values; and
an output to provide processed data based on the one or more estimated RDAz-based Doppler folds.

2. The apparatus of claim 1, wherein the processor is configured to determine a measurement vector corresponding to an RDAz bin based on the first plurality of values and the second plurality of values, and to determine an estimated RDAz-based Doppler fold corresponding to the RDAz bin based on the measurement vector corresponding to the RDAz bin.

3. The apparatus of claim 2, wherein the processor is configured to determine the estimated RDAz-based Doppler fold corresponding to the RDAz bin based on a matching between the measurement vector corresponding to the RDAz bin and a plurality of reference vectors corresponding to a respective plurality of Doppler fold values.

4. The apparatus of claim 3, wherein the processor is configured to identify a reference vector having a maximal match with the measurement vector corresponding to the RDAz bin, and to determine the estimated RDAz-based Doppler fold corresponding to the RDAz bin based on a Doppler fold value corresponding to the reference vector.

5. The apparatus of claim 3, wherein the plurality of reference vectors are based on a time difference between a second time and a first time, wherein the first time comprises a first transmission time of a first radar Tx signal from a first Tx antenna of the first plurality of Tx antennas, the second time comprising a second transmission time of a second radar Tx signal from a second Tx antenna of the second plurality of Tx antennas.

6. The apparatus of claim 1, wherein the processor is configured to determine a first plurality of azimuth-based values corresponding to the first plurality of virtual antennas based on the first plurality of values, to determine a second plurality of azimuth-based values corresponding to the second plurality of virtual antennas based on the second plurality of values, and to determine the one or more estimated RDAz-based Doppler folds based on the first plurality of azimuth-based values and the second plurality of azimuth-based values.

7. The apparatus of claim 6, wherein the processor is configured to determine an estimated RDAz-based Doppler fold corresponding to an RDAz bin, which corresponds to an Azimuth (Az) bin, based on a first subset of azimuth-based values in the first plurality of azimuth-based values and a second subset of azimuth-based values in the second plurality of azimuth-based values, wherein the first subset of azimuth-based values and the second subset of azimuth-based values correspond to the Az bin.

8. The apparatus of claim 7, wherein the processor is configured to determine a measurement vector corresponding to the RDAz bin based on the first subset of azimuth-based values and the second subset of azimuth-based values, and to determine the estimated RDAz-based Doppler fold corresponding to the RDAz bin based on the measurement vector corresponding to the RDAz bin.

9. The apparatus of claim 8, wherein the processor is configured to determine the measurement vector corresponding to the RDAz bin based on a Hadamard product of a first vector and a second vector, the first vector is based on the first subset of azimuth-based values, the second vector is based on the second subset of azimuth-based values.

10. The apparatus of claim 7, wherein the first subset of azimuth-based values corresponds to a first subset of virtual antennas in the first plurality of virtual antennas, wherein the second subset of azimuth-based values corresponds to a second subset of virtual antennas in the second plurality of virtual antennas.

11. The apparatus of claim 10, wherein the first subset of virtual antennas comprises a first column of virtual antennas in the virtual antenna array, and the second subset of virtual antennas comprises a second column of virtual antennas in the virtual antenna array.

12. The apparatus of claim 6, wherein the processor is configured to determine the first plurality of azimuth-based values based on a first plurality of sets of Fast-Fourier-Transform (FFT) values corresponding to a first plurality of virtual antenna rows in the first plurality of virtual antennas, and to determine the second plurality of azimuth-based values based on a second plurality of sets of FFT values corresponding to a second plurality of virtual antenna rows in the second plurality of virtual antennas.

13. The apparatus of claim 1, wherein the one or more estimated RDAz-based Doppler folds comprises a first estimated RDAz-based Doppler fold corresponding to a first RDAz bin, and a second estimated RDAz-based Doppler fold corresponding to a second RDAz bin.

14. The apparatus of claim 1, wherein the processed data comprises Doppler fold information to indicate the one or more estimated RDAz-based Doppler folds.

15. The apparatus of claim 14, wherein the processed data comprises processed radar data corresponding to the one or more RDAz bins, and the Doppler fold information comprising the one or more estimated RDAz-based Doppler folds.

16. The apparatus of claim 1, wherein the processor is configured to determine an estimated Doppler value for a target in an RDAz bin based on a sum of a Doppler value corresponding to the RD bin and an estimated RDAz-based Doppler fold corresponding to the RDAz bin, wherein the processed data is based on the estimated Doppler value.

17. The apparatus of claim 1, wherein an estimated RDAz-based Doppler fold comprises an estimated residual Doppler fold value resulting from a folding of an actual Doppler value according to a Doppler folding value.

18. The apparatus of claim 1, wherein the processor is configured to identify the one or more RDAz bins based on a detection criterion applied to the first plurality of values and the second plurality of values.

19. The apparatus of claim 1, wherein the first plurality of Tx antennas comprises a first column of Tx antennas, the second plurality of Tx antennas comprises a second column of Tx antennas, and the plurality of Rx antennas comprises a row of Rx antennas.

20. The apparatus of claim 19 comprising a controller configured to control transmission of the radar Tx signals in a sequence of Tx row transmissions via Tx rows of the Tx array.

21. The apparatus of claim 20, wherein an order of transmissions in the sequence of Tx row transmissions is different from an order of the Tx rows.

22. The apparatus of claim 20, wherein an order of transmissions in the sequence of Tx row transmissions is substantially random.

23. A product comprising one or more tangible computer-readable non-transitory storage media comprising instructions operable to, when executed by at least one processor, enable the at least one processor to:
process Range-Doppler (RD) information corresponding to an RD bin to identify a first plurality of values corresponding to a first plurality of virtual antennas of a virtual antenna array and a second plurality of values corresponding to a second plurality of virtual antennas of the virtual antenna array, wherein the RD information corresponding to the RD bin is based on radar Receive (Rx) signals received by a plurality of Rx antennas based on radar Transmit (Tx) signals from a Tx array including a first plurality of Tx antennas and a second plurality of Tx antennas, wherein the first plurality of virtual antennas is based on the plurality of Rx antennas and the first plurality of Tx antennas, the second plurality of virtual antennas is based on the plurality of Rx antennas and the second plurality of Tx antennas;
determine one or more estimated RD-Azimuth (RDAz) based (RDAz-based) Doppler folds corresponding to one or more RDAz bins based on the first plurality of values and the second plurality of values; and
provide processed data based on the one or more estimated RDAz-based Doppler folds.

24. The product of claim 23, wherein the instructions, when executed, cause the at least one processor to determine a first plurality of azimuth-based values corresponding to the first plurality of virtual antennas based on the first plurality of values, to determine a second plurality of azimuth-based values corresponding to the second plurality of virtual antennas based on the second plurality of values, and to determine the one or more estimated RDAz-based Doppler folds based on the first plurality of azimuth-based values and the second plurality of azimuth-based values.

25. A vehicle comprising:
a system controller configured to control one or more vehicular systems of the vehicle based on radar information; and
a radar system configured to provide the radar information to the system controller, the radar system comprising:
a Transmit (Tx) array to transmit radar Tx signals, the Tx array comprising a first plurality of Tx antennas and a second plurality of Tx antennas;
a plurality of Receive (Rx) antennas to receive radar Rx signals based on the radar Tx signals; and
a processor configured to:
process Range-Doppler (RD) information corresponding to an RD bin to identify a first plurality of values corresponding to a first plurality of virtual antennas of a virtual antenna array and a second plurality of values corresponding to a second plurality of virtual antennas of the virtual antenna array, wherein the RD information corresponding to the RD bin is based on the radar Rx signals, wherein the first plurality of virtual antennas is based on the plurality of Rx antennas and the first plurality of Tx antennas, the second plurality of virtual antennas is based on the plurality of Rx antennas and the second plurality of Tx antennas;
determine one or more estimated RD-Azimuth (RDAz) based (RDAz-based) Doppler folds corresponding to one or more RDAz bins based on the first plurality of values and the second plurality of values; and
provide processed data based on the one or more estimated RDAz-based Doppler folds, wherein the radar information provided by the radar system is based on the processed data.

26. The vehicle of claim 25, wherein the processor is configured to determine a measurement vector corresponding to an RDAz bin based on the first plurality of values and the second plurality of values, and to determine an estimated RDAz-based Doppler fold corresponding to the RDAz bin based on the measurement vector corresponding to the RDAz bin.
